(19) United States
(12) Patent Application Publication
(10) Pub. No.: US 2026/0111751 A1
(43) Pub. Date: Apr. 23, 2026

(54) SYSTEMS AND METHODS FOR PERFORMING TASKS USING LIGHTWEIGHT MODELS TRAINED USING DISTILLATION METHODS

(71) Applicant: NAVER CORPORATION, Seongnam-si (KR)

(72) Inventors: Juliette MARRIE, Meylan (FR); Michael ARBEL, Meylan (FR); Julien MAIRAL, Biviers (FR); Diane LARLUS, Meylan (FR)

(21) Appl. No.: 18/919,738

(22) Filed: Oct. 18, 2024

(51) Int. Cl. G06N 3/096; G06V 10/82

(52) U.S. Cl. CPC G06N 3/096; G06V 10/82

(57) ABSTRACT

In a method for training a lightweight student network model for performing a task, a pretrained network model larger than the lightweight student network model is augmented with a task-specific prediction head to provide a teacher model. The teacher model is trained on the downstream task using a task objective. The lightweight student network model is trained jointly using at least the task objective and a distillation objective. The distillation objective comprises a similarity between predictions from the lightweight student model and predictions from the trained teacher model.

### FIELD

The present disclosure relates generally to machine learning, and more particularly to methods and systems for training and implementing lightweight network models for performing tasks.

### BACKGROUND

In embodied artificial intelligence applications, large pretrained models, sometimes referred to as foundation or backbone models, are increasingly used for performing a broad variety of tasks. Large pretrained models are very costly to train, in that they typically require very large but often semi-manually curated sets of data and significant computing resources. Once trained, though, such models can generalize to such tasks with little effort.

For image processing, for instance, large pretrained models can be trained and used for performing visual recognition tasks such as image classification, object detection, semantic segmentation, and many others. However, training such large pretrained models can involve large amounts of visual data for image processing.

By contrast, many real-world applications could benefit from compact, task-specific or specialized models, which are sometimes referred to as lightweight models. Lightweight models can be useful to improve processing speed and may be deployed in many contexts where large pretrained models would be too large.

Knowledge distillation (distillation) is a method for transferring knowledge from one model (teacher) into another (student). Distillation has been used, for instance, to transfer knowledge from a large teacher network trained on a specific task to a small student network, e.g., as disclosed in Hinton et al., Distilling the knowledge in a neural network. arXiv preprint arXiv:1503.02531, 2015; Ba & Caruana, Do deep nets really need to be deep? In Advances in Neural Information Processing Systems (NIPS), 2014.

More recently, distillation has been used to transfer general representations produced by a large generic model into small ones. Examples of such distillation methods are disclosed in, e.g., Koohpayegani et al., Compress: Self-supervised learning by compressing representations, In Advances in Neural Information Processing Systems (NeurIPS), 2020; Fang et al., SEED: Selfsupervised distillation for visual representation, In Proceedings of the International Conference on Learning Representations (ICLR) 2021; Xu et al., Bag of instances aggregation boosts self-supervised distillation, In Proceedings of the International Conference on Learning Representations (ICLR), 2022; Gao et al., Disco: Remedy self-supervised learning on lightweight models with distilled contrastive learning, In Proceedings of the European Conference on Computer Vision (ECCV), 2022; Navaneet et al., Simreg: Regression as a simple yet effective tool for self-supervised knowledge distillation, In Proceedings of the British Machine Vision Conference (BMVC), 2021; Wu et al., TinyViT: Fast pretraining distillation for small vision transformers, In Proceedings of the European Conference on Computer Vision (ECCV), 2022; Duval et al., A simple recipe for competitive low-compute self supervised vision models, arXiv preprint arXiv:2301.09451, 2023); and others.

In such methods, distillation is used as a knowledge compression mechanism, taking advantage of the principle that directly pretraining small models on large amounts of data leads to underwhelming results compared to learning them by distillation from large pretrained models.

However, existing methods for training compact specialized models using distillation have been insufficient.

### SUMMARY

Provided herein are computer-implemented systems and methods for training a lightweight student network model for performing a task, and applications therefor. A pretrained network model larger than the lightweight student network model is augmented with a task-specific prediction head to provide a teacher model. The teacher model is trained on the task using a task objective. The lightweight student network model is trained jointly using at least the task objective and a distillation objective, where the distillation objective comprises a similarity between predictions from the lightweight student model and predictions from the trained teacher model. The trained lightweight student network model can be stored. One or more tasks may be performed using the trained lightweight student network model.

According to a complementary aspect, the present disclosure provides a computer program product, comprising code instructions to execute a method according to the previously described aspects; and a computer-readable medium, on which is stored a computer program product comprising code instructions for executing a method according to the embodiments and aspects described herein. The present disclosure further provides a processor configured using code instructions for executing a method according to the described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 shows an example processor-based task-specific distillation architecture.

FIG. 2 shows steps in an example method for training a lightweight student network model.

FIG. 3 shows steps in an example method for generating an extended dataset from an original dataset such as a labeled dataset.

FIG. 4 shows an example information flow during an example method for training a student.

FIG. 5 shows an example processor-based device in which a trained (distilled) lightweight network model may be implemented for performing a task from a new input in an inference method

FIG. 6 shows steps in an example inference method.

FIG. 7 shows results from probing/finetuning of DINOv2 pretrained models for classification on DomainNet, fine-grained classification, and semantic segmentation, along with accuracy for classification and mIoU for segmentation.

FIG. 8 shows results from distillation according to example methods on an example transformer-based model, ViT-S, initialized with DINOv2 for classification on DomainNet, fine-grained classification, and semantic segmentation, along with accuracy for classification and mIoU for segmentation. Experimental results are shown with and without example data augmentation based on Stable Diffusion (SD), for various choices of teachers. Relative gains with respect to simple probing or finetuning (best are underlined in FIG. 7) are in parentheses. Bold numbers are within 95% confidence interval of the best score for each task.

FIG. 9 shows results from distillation according to example methods from an example transformer-based model, ViT-g, to ResNet-50 (resp. DeepLabv3-ResNet50 for segmentation) trained from scratch for classification on DomainNet, fine-grained classification, and semantic segmentation, along with accuracy for classification and mIoU for segmentation. Experimental results are shown with and without example data augmentation based on Stable Diffusion (SD). Relative gains with respect to simple training (underlined) are in parentheses. Bold numbers are within 95% confidence interval of the best score for each task.

FIG. 10 illustrates an overview of example distillation methods, and example generated synthetic images producing features shown in gray in the teacher plot. Each plot shows image features for 30 classes of the CUB Bird dataset, after principal component analysis (PCA) (one color per class). In experiments, a large pretrained teacher (top, left) was distilled to train a small task-specific student model (top, right).

FIG. 11 shows a principal component analysis (PCA) of patch embedding representations for 20 classes of ADE20K for a ViT-g teacher (a) and for the ViT-S student in its initial state (b), after finetuning (c) and after example distillation methods (d), colored by their main class, illustrating that classes are better clustered after example distillation methods than after finetuning.

FIGS. 12A-12C show example images generated for the CUB (e.g., as disclosed in Wah et al., Technical Report CNS-TR-2011-001, California Institute of Technology, 2011), Pascal VOC (e.g., as disclosed in Everingham et al., The pascal visual object classes (voc) challenge, International Journal of Computer Vision (IJCV), 88(2):303-338, 2010) and for DomainNet's Painting (e.g., as disclosed in Peng et al., Moment matching for multi-source domain adaptation, In Proceedings of the International Conference on Computer Vision (ICCV), 2019).

FIGS. 12D-12F show additional visualizations of the synthetic images produced by an example augmentation protocol based on stable-diffusion for ADE20K (Zhou et al., 2017), DomainNet's Sketch (Peng et al., 2019), and DTD (Cimpoi et al., 2014).

FIG. 13 illustrates distillation results in experiments building an extended dataset [symbol] _{sd} by augmenting a training dataset [symbol] ₜᵣₐᵢₙ. Distillation results using ViT-g as a teacher and ViT-S or ResNet-50 as a student using a mixing data augmentation approach according to example methods are compared with i) a model producing image variations from single images (ImageVariations); ii) incorporating a subset of ImageNet; and iii) text-to-image diffusion using the parent class only, i.e., bird, aircraft, or texture (“A photo of a {parent class]”), or using class information as well (“A photo of a {class name}{parent class}”).

FIG. 14A illustrates an impact of synthetic data on experimental distillation and task losses, including an impact on fine-grained classification tasks for finetuning and for example distillation methods with ViT-S as student and ViT-g as teacher, using an extended dataset [symbol] _{sd-intra} augmented with synthetic images by mixing original images inside each class separately.

FIG. 14B illustrates an example role of different finetuning and distillation losses, including a comparison of optimizing [symbol] ₜᵣₐᵢₙ only (i.e., finetuning), [symbol] _{distill} only, or both losses with equal weighting (standard distillation). Results presented are with Vit-S as student and ViT-g as teacher.

FIG. 15 shows an example architecture in which example methods can be implemented.

In the drawings, reference numbers may be reused to identify similar and/or identical elements.

### DETAILED DESCRIPTION

### Introduction

For self-supervised learning, knowledge distillation has emerged as a compelling way to compress large pretrained models into smaller ones, yielding significant improvements compared to directly pretraining the smaller models.

Some existing distillation methods finetune distilled models on various downstream tasks without further exploiting the teacher's knowledge. Illustrative examples of such distillation methods are disclosed in Sun et al., Patient knowledge distillation for BERT model compression, In Proceedings of the Conference on Empirical Methods in Natural Language Processing (EMNLP), 2019; Touvron et al., Training data-efficient image transformers & distillation through attention, In Proceedings of the International Conference on Machine Learning (ICML), 2021; and Beyer et al., Knowledge distillation: A good teacher is patient and consistent, In Proceedings of the IEEE/CVF Conference on Computer Vision and Pattern Recognition (CVPR), 2022.

The present inventors have recognized that simply finetuning such small pretrained models yields sub-optimal results compared to leveraging the knowledge of the larger models for a specific downstream task. While smaller models can be produced that are distilled from larger ones on a sizeable generic dataset, it may not be desirable to simply finetune such models to specific tasks. As a nonlimiting example, as visual pretrained models become larger, finetuning such models may be impractical or even infeasible due to the required costs.

Other methods consider a task-specific distillation procedure that leverages both the teacher and the downstream task. “Task-specific distillation” refers to training a small model for a particular supervised task while (i.e., in the same overall process) transferring knowledge from a large pretrained model. Illustrative prior examples include two-stage distillation methods used in applications such as natural language processing (e.g., Jiao et al., Tiny-BERT: Distilling BERT for natural language understanding, In Findings of the Association for Computational Linguistics: EMNLP, 2020) and vision tasks (e.g., Huang et al., Generic-to-specific distillation of masked autoencoders, In Proceedings of the IEEE/CVF Conference on Computer Vision and Pattern Recognition (CVPR), 2023). Such two-stage distillation methods involve a conventional generic distillation, followed by finetuning the teacher on a downstream task and then applying a second task-specific distillation involving the fine-tuned teacher, which is computationally demanding.

Additionally, prior distillation approaches may be architecture-dependent, in that they require directly exploiting the specific architecture of both the teacher and the student. For example, architecture-dependent distillation approaches may include feature-based knowledge distillation tailored to convolutional neural networks (CNNs), where knowledge is distilled by matching representations from any intermediate layer(s), or by aligning mutual relations in the feature space. Other architecture-dependent distillation approaches may be specific to transformers, such as including the addition of a separate distillation token. Such approaches, however, limit the ability to exploit the versatility of large pretrained models.

Methods and systems herein provide, among other things, training of compact, task-specific neural network models for performing a downstream task using knowledge distillation (distillation) via large pretrained models. Compact, task-specific neural network models may also be referred to as lightweight models, and models trained using example distillation methods herein may be referred to as lightweight student network models.

Present training methods and systems can benefit from the knowledge of existing large pretrained models, leveraging such models to build the lightweight student network models. Using example distillation methods such as provided herein, the information captured by a large and more generic foundation model can be distilled into a more compact specialized model or network.

Generally, in example training methods and systems herein, a large pretrained network model is augmented and trained on a task during a probing stage to provide a teacher model (teacher). Then, the trained teacher is used for training a lightweight student network model (student) via distillation in a distillation stage.

As opposed to simply finetuning the large pretrained network model, for instance, an example probing stage augments (e.g., couples or connects) the large pretrained network model with a task-specific prediction head and optimizes the task-specific prediction head on a downstream task. A task-specific prediction head herein refers to a head for training on the downstream task (e.g., a prediction task). Task-specific prediction heads may be relatively simple or more complex. An example task-specific prediction head, for instance, may include or be embodied in a simpler configuration such as but not limited to one or more linear layers, or a small multilayer perceptron (MLP), a more complex head such as but not limited to convolutional upsampling or similar head, or configured in otherways. A suitable or optimal type of task-specific head for a task may be selected using one or more default or general configurations and/or selected or modified via evaluation or testing. The task-specific prediction head (e.g., having task-specific prediction head trainable parameters) is optimized on a task objective while parameters of (e.g., a subset, up to the entirety of) the large pretrained network model may be frozen. A task objective refers to an objective function relating to the task, which may be used to determine an associated task loss. The augmented large pretrained model provides a teacher model.

The teacher model thus provided is then used in the distillation stage to guide the training of a smaller model (the student) that is specialized for a given task (e.g., the downstream task used to probe the teacher model). Prior to the distillation stage, the student (e.g., trainable parameters of the student) may be pretrained and/or initialized in any suitable manner. The teacher model (e.g., model parameters of the teacher model, including the large pretrained model and the task head) may be partially or entirely frozen during the distillation stage.

An example distillation stage trains the student jointly using at least two objectives: a task objective (e.g., such as the task objective for the probing stage, which may be used to determine an associated task loss); and a distillation objective (e.g., which may be used to determine an associated distillation loss) based on a similarity of predictions between the trained teacher model and the student. The task objective may be a supervised objective, while the distillation objective need not be supervised (though it may be). These objectives may be combined, e.g., with one or more weighting parameters and/or one or more additional objectives, into a combined objective used to optimize parameters of the student network model.

Example task and distillation objectives are provided herein for illustrating useful features, though it will be appreciated that other task and distillation objectives are possible, including modifications. Further, example data augmentation methods are provided herein for providing extended datasets that may be used to enhance training during the distillation stage.

The resulting trained (distilled) lightweight student network model, e.g., architecture and optimized parameters, or optimized parameters alone, can be stored, and/or the trained lightweight student network model may be implemented into any suitable environment for performing the task, alone or in addition to other upstream or downstream tasks. Example training methods may be especially useful for providing and implementing lightweight models in environments where large pretrained models, or their training, would be less feasible or less suitable. However, it will be appreciated that lightweight models can also be implemented into environments in place of or in addition to large pretrained models.

The present inventors have found that, in training, it is useful to retain the versatility that the large pretrained models have acquired during pretraining. Example systems and methods herein can thus provide a task- and architecture-agnostic distillation framework. Such systems and methods can avoid the need to adjust to the model's architecture.

Examples of architecture-agnostic distillation approaches, which rely on particular loss functions, are disclosed in, as an illustrative example, Tian et al., Contrastive representation distillation, In Proceedings of the International Conference on Learning Representations (ICLR), 2020, which discloses a contrastive objective inspired by self-supervised learning approaches. Other illustrative examples are disclosed in Zhao et al., Decoupled knowledge distillation, In Proceedings of the IEEE/CVF Conference on Computer Vision and Pattern Recognition (CVPR), 2022.

Example methods and systems herein can be used to leverage the knowledge in large pretrained models for various applications that may be constrained by limited resources. Example training methods and systems are also generally applicable to a variety of tasks and models. For image processing applications, as a nonlimiting example, large pretrained visual models have demonstrated robust generalization across diverse computer vision tasks. Such models conventionally have been developed by leveraging substantial computing resources, being trained on very large, often internal, sets of visual data to learn rich visual representations. While pretrained visual models trained thusly can exhibit strong transfer performance on downstream tasks, the large size of the best performing models often poses limitations for various real-world applications, e.g., in terms of inference time and memory usage, especially in scenarios with constrained resources. Example training methods and systems herein, on the other hand, can be employed to more effectively transfer rich visual representations from large pretrained models to a smaller architecture.

Experiments illustrating features of example methods and systems herein were conducted using DINOv2 teachers, e.g., Oquab et al., DINOv2: learning robust visual features without supervision, Transactions on Machine Learning Research (TMLR), 2024, and extended to EVA-02 MIM- and CLIP-pretrained models, e.g., Fang et al., EVA-02: A visual representation for neon genesis, arXiv preprint arXiv:2303.11331, 2023; Sun et al., Eva-clip: Improved training techniques for clip at scale, arXiv preprint arXiv:2303.15389, 2023, demonstrates good results across different architectures and various tasks, including the example tasks of classification on specific image modalities, fine-grained classification, and semantic segmentation. The experiments demonstrate that example methods and systems herein can provide a straightforward, cost-efficient approach to supervised distillation from large pretrained models, while achieving competitive or even superior results compared to prior methods.

### Architecture and Method

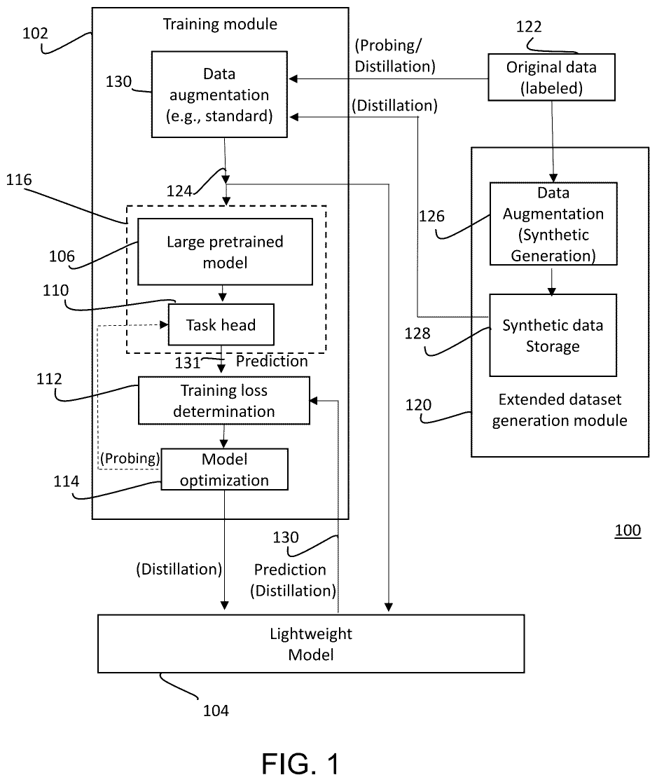

Turning now to the drawings, FIG. 1 shows an example processor-based task-specific distillation architecture 100, which includes a training module 102 for training a lightweight student network model (lightweight model)104 coupled thereto for performing a task. The task may be any suitable task for which a lightweight model can be implemented and may also be referred to as a target task. Example tasks are described herein relating to image processing, but it will be appreciated that present methods are generally applicable to other training for other tasks.

The training module 102 includes a large pretrained model 106, for instance a backbone model, that is larger than the small or lightweight model 104. The large pretrained model 106 includes model parameters (e.g., backbone model parameters), and the lightweight model 104 includes trainable lightweight model parameters. Example model parameters for the large pretrained model 106 and the lightweight model 104 can vary depending on the model architectures that are used, as will be appreciated by an artisan. A nonlimiting example large pretrained model 106 is embodied in an encoder. Illustrative example encoders are provided herein, though other encoders or large pretrained models are possible.

“Small” or “lightweight” for a model as used herein refers to a number of model parameters and/or to an amount of involved or required computing resources such as memory usage. A “large” model may refer to a model that is larger than a small model by any suitable ratio of model parameters and/or of involved or required computing resources, e.g., greater than 1×, greater than 2×, greater than 5×, greater than 10×, greater than 20×, etc. For example, a “large” model may be too large to operate in practice on a network appliance (e.g., a robot), a portable device, a device with limited available processing power or other power, etc., with limited computation resources (e.g., in terms of processing power and/or memory) that may support a “small” or “lightweight” model.

The training module 102 further includes a task-specific prediction head (task head) 110 that is directly or indirectly connected or coupled to the large pretrained model 106, e.g., downstream of the large pretrained model 106, augmenting the large pretrained model to provide (e.g., construct) a teacher model 116. The task head 110 includes trainable prediction head parameters. An example task head 110 is a small (relative to the pretrained model 106) layer or block that can be connected to the pretrained model and trained for performing the task, for instance while the large pretrained model 106 is partially or completely frozen, such as by freezing all of a subset of the parameters of the pretrained model. An example task head 110 may be embodied in, for instance, a one- or two-dimensional (2D) multilayer perceptron (MLP) or linear layer, though other embodiments are possible. A selection of the task head (e.g., linear vs. MLP, number of layers, etc.) may be made to provide improved results, e.g., based on an evaluation of results with one or more configurations. For instance, for some classification tasks, an MLP task head may provide improved results, such as by improving accuracy of teacher models and/or their effectiveness in distillation over linear layers. The number of layers for the task head can be small, e.g., one or two layers, though more than two layers could also be used. Testing or evaluation may be used to select one or more optimal task head configurations.

The teacher model 116 is trained on a task during a probing stage, examples of which are explained in further detail below, to optimize parameters of the task head 110. After the probing stage, the trained teacher model 116 is then used in a subsequent distillation stage that trains the lightweight model 104 for a task (e.g., the task used during the probing stage).

A training loss determination module 112 and a model optimization module 114 are provided for training the large pretrained model 106 augmented with the task-specific prediction head 110 (that is, the constructed teacher model 116) during the probing stage and for distilling the lightweight model 104 using the teacher model during the distillation stage. The training loss determination module 112 determines a training loss according to a training objective, which may include a task objective during the probing stage and include both a loss objective and a distillation objective during the distillation stage, though additional objectives to these may also be used. The model optimization module 114 optimizes model parameters of the task head 110 of the teacher model 116 during the probing stage (shown as a dashed arrow in FIG. 1) based at least on the task objective, while the parameters of the large pretrained model 106 are partially or completely frozen. Additionally, the model optimization module 114 optimizes model parameters of the lightweight model 104 during the distillation stage based at least on the task objective and on the distillation objective, while the parameters of both the large pretrained model 106 and the task head 110 (i.e., parameters of the teacher model 116) are partially or completely frozen.

Additionally, to enhance distillation during the distillation stage, the task-specific distillation architecture 100 may include an extended dataset generation module 120 for generating additional data from original data, e.g., labeled original data 122, to augment the original data and provide an extended dataset combining the original and generated additional data. The original data 122 may be, for instance, labeled original data, and in some examples includes labeled images. However, the generated additional data need not be labeled, though it may be, and generating the additional data need not consider labels, though it may. The example extended dataset generation module 120 includes a synthetic data generation module 126 for generating synthetic data from the original data 122, which generated data may be stored in a synthetic data storage 128.

Training data is provided to the teacher model 116 during the training stage and the distillation stage and provided to both the (trained) teacher model and the lightweight model 104 during the distillation stage. For instance, during the probing stage, a dataset from the labeled original data 122 may be provided to the training module 102. For the task objective of the distillation stage, a dataset from the labeled original data 122 may be provided to the lightweight student network model 104. For the distillation objective of the distillation stage, an extended dataset including both data from the labeled original data 122 and data from the synthetic data storage 128 may be input to the training module 102 and to the lightweight model 104.

The original dataset 122 and/or the synthetic data from synthetic data storage 128 may be provided to a data augmentation module 130 for performing data augmentation (e.g., classical or standard data augmentation) that is useful during training. The data augmentation module 130 may perform data augmentation during training or prior to training. The dataset and/or the augmented data generated using the original data 122, may be provided, e.g., as input data 124, to the teacher model 116 and to the lightweight model 104 as needed.

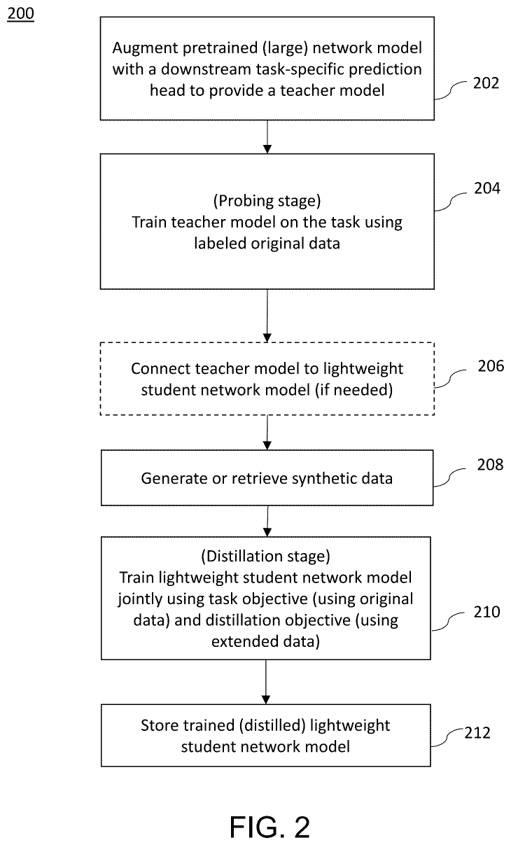

FIG. 2 shows an example training method 200 that may be performed using the training module 102 for training a lightweight student network model, e.g., lightweight model 104, for performing a task. The training module 102 may be implemented using one or more processors and associated memory (or memories).

To construct a teacher model such as the teacher model 116, a large pretrained network model, e.g., large pretrained model 106, having pretrained network model parameters, is augmented at 202 with a downstream task-specific prediction head, e.g., task head 110, having task head parameters. The large pretrained model 106, e.g., having pretrained network model parameters, may be initialized and/or pretrained in any suitable manner. In some example methods, the large pretrained model 106 is pretrained via self-supervised training. For illustration only, for image classification tasks a teacher model 116 such as an encoder (e.g., a transformer-based encoder such as a vision transformer (ViT)) may be based on DINOv2-pretrained models (e.g., as disclosed in Oquab et al., DINOv2: learning robust visual features without supervision, Transactions on Machine Learning Research (TMLR), 2024), EVA-02 models pretrained with masked information modeling (MIM) (e.g., as disclosed in Fang et al., EVA-02: A visual representation for neon genesis, arXiv preprint arXiv:2303.11331, 2023) or CLIP-pretrained models (e.g., as disclosed in Sun et al., Eva-clip: Improved training techniques for clip at scale, arXiv preprint arXiv:2303.15389, 2023), or others. The task head 110 parameters may be initialized in any suitable manner.

During a probing stage, the teacher model 116 (that is, the augmented pretrained network model) is trained on the task at 204 using a task objective. In an example training step 204, the pretrained network model parameters, e.g., of large pretrained model 106, or a subset thereof, are frozen, and the task-specific network parameters, e.g., of task head 110, are optimized, such as by the model optimization module 114 using a task objective with a task loss determined by the training loss determination module 112. Example task objectives are provided below. The task objective may be supervised. For example, the training 204 may include providing labeled input data 124, which may be augmented by the data augmentation module 130, e.g., on the fly, using, for instance, one or more data augmentation techniques available to those of ordinary skill in the art, to the augmented pretrained network model from the original labeled data 122. The augmented pretrained network model processes the input data 124 and makes a prediction (e.g., an output from the task head 110). A task loss is determined by the training loss determination module 112 based on the task objective, and the model optimization module 114 optimizes the task-specific network parameters based on the determined task loss. Example optimization methods that may be used are provided herein, and others will be appreciated by those of ordinary skill in the art.

The augmenting and training steps 202, 204 for the probing stage may be performed independently and/or separately from the subsequent distillation stage 210. The augmenting and training 202, 204 may be performed in advance, even well in advance of the distillation stage. For example, the resulting trained teacher model 116 may be stored in non-transitory storage for later retrieval and used in the distillation stage 210, may be stored in memory and used immediately for distillation, or any combination. The same trained teacher model 116 may be used for training one, or more than one, lightweight model via distillation. The augmenting and training 202, 204 may be performed using the same processor or a different processor than used for the distillation stage 210. Reference herein to a “processor” may thus refer to one or more processors, and reference to multiple steps need not require that subsequent steps be performed immediately following prior steps.

The teacher model 116, e.g., the pretrained network model 106 augmented with the task head 110 and trained, is directly or indirectly connected at 206 to the lightweight student network model 104, if needed (that is, if not already connected). The lightweight student network model (e.g., the lightweight student network model parameters) may be initialized and/or pretrained. Initialization and pretraining may be performed using any suitable methods. In some example methods, the lightweight student network model 104 may be pretrained using a task-agnostic distillation method, which may complement the (task-specific) distillation stage 210. For use in the distillation stage 210, synthetic data for an extended dataset may be retrieved or, if not already generated, may be generated at 208. The data, whether from the original dataset or the synthetic data, may be augmented as needed, e.g., on the fly, using data augmentation module 130.

In the distillation stage 210, the lightweight student network model 104 is trained jointly on at least a task objective, e.g., the task objective used during the probing stage (training step 204), as well as on a distillation objective. For instance, the task objective may be a supervised objective, and the associated task loss may be determined by the training loss determination module 112 using labeled data, e.g., from the labeled original data 122. The distillation objective, on the other hand, may be an unsupervised objective, with an associated task loss determined by the training loss determination module 112, based on or including a similarity (or corresponding dissimilarity) between predictions 130 generated from the lightweight student model 104 and predictions 131 generated from the trained teacher model 116, though it is possible that a supervised objective could also be used. To further enhance distillation, the distillation objective may be over the extended dataset including the original data 122 and the synthetic data generated by the synthetic data generation module 126 and stored in the synthetic data storage 128, which data may be retrieved at step 208.

Example distillation losses and associated features that may be used include but are not limited to, classical knowledge distillation loss (e.g., as disclosed in Hinton et al., Distilling the knowledge in a neural network, arXiv preprint arXiv:1503.02531, 2015); hard-label distillation, which includes a cross-entropy loss with the hard label prediction produced by the teacher for learning their distillation token (e.g., as disclosed in Touvron et al., Training data-efficient image transformers & distillation through attention, In Proceedings of the International Conference on Machine Learning (ICML), 2021); CRD (e.g., as disclosed in Tian et al., Contrastive representation distillation, In Proceedings of the International Conference on Learning Representations (ICLR), 2020), which aligns teacher and student representations through a contrastive learning objective; and DKD (e.g., as disclosed in Zhao et al., Decoupled knowledge distillation, In Proceedings of the IEEE/CVF Conference on Computer Vision and Pattern Recognition (CVPR), 2022), which decomposes the classical knowledge distillation loss into target-class and non-target-class losses.

During the distillation step 210, the trained teacher model 116 can remain partially or completely frozen. The model optimization module 114 optimizes model parameters of the lightweight student network model 104 to provide a trained (distilled) lightweight student network model. The distilled lightweight student network model, now trained for the task, can be stored at 212, e.g., in non-transitory storage for later implementation and/or use in inference, or for further training if desired.

The original data 122 and/or the extended dataset may be augmented, e.g., on the fly, by the data augmentation module 130 for use in training. Data augmentation methods may include, as nonlimiting examples, standard or conventional data augmentation methods using the original dataset, or using the combination of original and synthetic data (the extended dataset). Example data augmentation methods are provided herein for illustration. The same original dataset and/or extended dataset may be used to generate one or multiple augmented datasets.

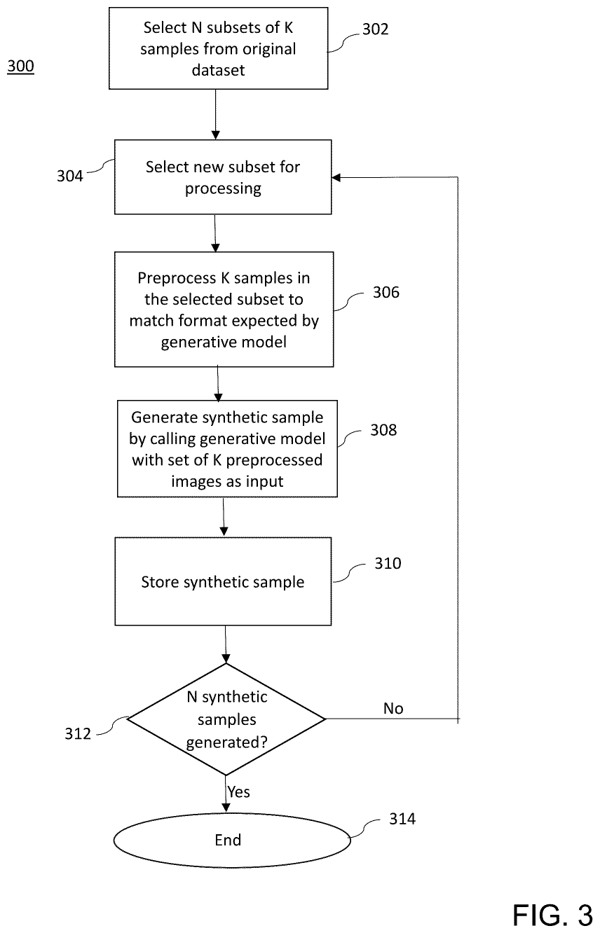

FIG. 3 shows an example method 300 for generating an extended dataset at 208 from an original dataset such as the original labeled data 122 by employing a generative model to generate a set of synthetic samples. An example generative model is a diffusion-based model, a nonlimiting example being Stable Diffusion, though other generative models may be used. The original labeled data 122 includes original data and corresponding labels. However, the method 300 may be task-agnostic, in that the extended dataset may be generated with or without considering the labels, and the method may produce data that need not be labeled for its use. An example task-agnostic mixing approach can produce synthetic data from combinations of samples, regardless of their classes. The same original data may be used to generate one or multiple synthetic datasets.

In an example method for generating a set of N synthetic samples for a synthetic dataset given the original dataset and the generative model (for example, a set of N synthetic images from an original dataset of images), N subsets of K samples (e.g., K original images) are selected from the original dataset at 302. K may be essentially any number, but as a nonlimiting example is between 2≤K≤5. For example, the selection step 302 may be performed by taking all or a subset of possible combinations of K samples among all (or a subset of) data in the original dataset. The selection step 302 may be performed with or without considering the data's labels.

The K samples in each subset are processed to generate each of N synthetic samples using the generative model. For example, a subset from among the N subsets may be selected for processing at 304. The K samples in the selected subset may be preprocessed at 306 as needed or desired to comply with (e.g., match), or better comply with, the format that is expected for an input to the generative model. This preprocessing may be conducted using any suitable method. For instance, an additional, embedding model may be called for generating one or more embeddings from the K samples.

A new synthetic sample is generated at 308 using the generative model, e.g., by calling the generative model with the set of K samples (modified or embedded at preprocessing step 306) as input. The generated synthetic sample is stored at 310 to provide part of the synthetic dataset. If N synthetic samples have not been generated at 312, a new subset from among the N subsets is selected at 304 for generating another synthetic sample. If all N synthetic samples have been generated at 312, the process ends at 314.

The synthetic data generated from the generative model can be stored, e.g., in a non-transitory storage, at 310 for retrieval at step 208 and used along with the original data during the distillation stage 210 as part of the extended dataset. The synthetic data may be stored separately at 310 and combined with the stored original data 122 to provide the extended dataset. In other embodiments, the synthetic data may be combined with the original data before storage to provide a stored extended dataset, which may replace or be stored in addition to the stored original data 122. The extended dataset may be used for distilling one or multiple lightweight models.

### Example Training Model

For illustrating inventive features, an example training model for task-specific distillation of a lightweight student network model will now be described with respect to an image processing task. Example image processing tasks include but are not limited to image classification, object detection, or semantic segmentation (or a combination). The example large pretrained model in the illustrative example model below is embodied in an encoder, which provides a backbone model. A nonlimiting example encoder useful for distilling for image processing tasks is a vision transformer (ViT), examples of which are provided herein. However, those of ordinary skill in the art will appreciate that the example training model can be extended to training for other tasks and may use other large pretrained models.

Generally, an example task-specific distillation method trains a teacher model (teacher) on a target task in a probing stage, e.g., training step 204, and then transfers knowledge from the trained teacher model to a student model (student) in a distillation stage, e.g., distillation stage 210. Example distillation methods can be performed without teacher finetuning by instead training a task head 110 of the teacher model 116 coupled to (e.g., downstream of) a pretrained model such as large pretrained model 106. Finetuning can be computationally expensive, especially when dealing with large teachers such as encoders. Finetuning may also compromise the quality of the representation, such as visual representation, acquired during pretraining (e.g., from self-supervision). However, it is also possible to combine teacher probing and finetuning.

Consider a task such as classification or segmentation, where the goal is to predict a label y (e.g., a class or a segmentation map) given an input image x. Typically, one could learn a model f to perform such a task using a training set [symbol] ₜᵣₐᵢₙ of labeled data, e.g., image/labels pairs (x,y), by simply optimizing the following training loss (training loss may be, but need not be, regularized in example methods):

$${ℒ}_{task} ( f ) = {ℝ}_{( x , y ) ∼ {𝒟}_{train}} {ℓ}_{task} ( f ( x ) , y ) . \qquad ( 1 )$$

One could directly leverage a pretrained model by using it to initialize the model f, and then performing either finetuning or probing using objective [symbol] ₜₐₛₖ(f). However, such direct approaches require using the same architecture as the original pretrained model. This can be limiting, e.g., for applications where inference speed and memory are critical factors. By contrast, example distillation methods herein learn a lightweight or small model fₛ (e.g., lightweight model 104) that can still leverage knowledge from a much larger pretrained model (e.g., large pretrained model 106), such as a pretrained encoder model eₜ (or other model), to perform the task.

To this end, an example distillation method first (“first” being relative to later steps described below, though other, previous steps may occur, such as but not limited to pretraining or initialization) constructs a teacher model fₜ from the pretrained model, e.g., encoder eₜ, using a probing approach, and then uses the probed teacher model to distill knowledge relevant to the task on the lightweight model fₛ in a distillation stage.

### Probing Stage

An example probing approach augments, e.g., in augmenting step 202, the pretrained model 106, e.g., encoder model eₜ, with a task-specific prediction head pₜ creating a teacher model fₜ (i.e., fₜ(x)=pₜ(eₜ(x))). The teacher model is then trained, e.g., in training step 204, for a supervised, target task by training the prediction head pₜ to minimize a training loss [symbol] ₜₐₛₖ(fₜ).

The parameters of the pretrained model, e.g., of encoder eₜ, can remain frozen (or at least partially frozen) during the example probing step. This not only significantly reduces the training cost compared to finetuning but it also helps preserve information acquired during (e.g., self-supervised or other) pretraining. Experiments demonstrate that this teacher training model can lead to better distillation results than its finetuned version in general.

### Distillation Stage

After training the teacher model fₜ, an example distillation step 210 uses the teacher model 116 to guide the training of a smaller student model fₛ, e.g., lightweight model 104, on a task (e.g., the supervised, target task). An example distillation step supplements a task loss [symbol] ₜₐₛₖ with a distillation loss [symbol] _{distill} that encourages the student's predictions to match the teacher's, resulting in an overall objective of the form:

$$ℒ ( {f}_{s} ) := ( 1 - α ) {ℒ}_{task} ( {f}_{s} ) + α {ℒ}_{distill} ( {f}_{s} , {f}_{t} ) . \qquad ( 2 )$$

In Equation (2), α is a weighting parameter controlling the strength of the distillation loss. [symbol] _{distill} may be defined, for instance, as an average of some dissimilarity measure [symbol] _{d} between the student's and the teacher's predictions over a set [symbol] of data such as images, e.g., well-chosen images:

$${ℒ}_{distill} ( {f}_{s} , {f}_{t} ) = {𝔼}_{x , . ) ∼ 𝒟} [ {ℓ}_{d} ( {f}_{s} ( x ) , {f}_{t} ( x ) ) ] . \qquad ( 3 )$$

The loss in Equation (3) ensures that the example distillation protocol is agnostic to the architecture since the dissimilarity measure [symbol] _{d} here depends solely on the student's and the teacher's outputs and not on their internal structure. An example dissimilarity measure [symbol] _{d} can be set, as a nonlimiting example, to be a KL-divergence rescaled by a temperature parameter T, such as disclosed in Hinton eₜ al. Distilling the knowledge in a neural network, arXiv preprint arXiv:1503.02531, 2015:

$${ℓ}_{d} ( {f}_{s} ( x ) , {f}_{t} ( x ) ) = {T}^{2} {D}_{KL} ( \frac{{f}_{s} ( x )}{T} \vert \vert \frac{{f}_{t} ( x )}{T} ) . \qquad ( 4 )$$

Data Augmentation for Distilling with Extended Data

The choice of data, e.g., images [symbol] , in the distillation loss (Equation (3)) is significant, as it defines the nature of the data (here, images) for which the student is required to match the teacher's predictions. While it may be intuitive to define D as the set of training data, e.g., training images [symbol] ₜᵣₐᵢₙ, this choice is not necessarily the most effective for extracting relevant knowledge from the teacher as [symbol] ₜᵣₐᵢₙ may offer a view that is too narrow.

Instead, example distillation methods can build D by extending [symbol] ₜᵣₐᵢₙ using a data augmentation protocol. An example data augmentation method, e.g., data augmentation method 300, is based at least in part on a generative model, such as may be used in synthetic data generation step 302. Such data augmentation methods can leverage the teacher's knowledge more effectively to enhance the distillation process. Features of example data augmentation methods will now be described.

It is useful to ensure that a sufficient number of samples are available to distill from, as there may be a lack of existing samples for some downstream tasks. Data augmentation has been used to improve generalization capabilities of deep neural networks, e.g., as disclosed in Wang & Yoon, Knowledge distillation and student-teacher learning for visual intelligence: A review and new outlooks, IEEE Transactions on Pattern Analysis and Machine Intelligence (PAMI), 44 (6):3048-3068, 2021. Distillation has been shown generally to benefit from data augmentation, e.g., as disclosed in Beyer et al., Knowledge distillation: A good teacher is patient and consistent, In Proceedings of the IEEE/CVF Conference on Computer Vision and Pattern Recognition (CVPR), 2022.

In example training methods, the task objective may be provided over an original dataset, e.g., a labeled dataset [symbol] ₜᵣₐᵢₙ having original data and corresponding labels. The distillation objective, on the other hand, may be provided over an extended dataset that includes the labeled dataset but is further augmented with additional data, which need not be labeled (though it may be). The example distillation process above can align the teacher's and student's outputs for a set of data, e.g., images [symbol] , that is sufficiently large and diverse to extract relevant knowledge.

While it is possible to augment a dataset with standard or conventional data augmentation, doing so may not introduce enough diversity. To provide increased diversity for an image-related task (for instance), generating images relevant to the task, e.g., with suitable semantics and originating from the correct domain, is useful. However, it is also useful for generation of additional data (e.g., image generation) to be task-agnostic to avoid the need for manual tailoring to each downstream task, or to avoid providing class names or any other ground truth.

Example methods herein can leverage generative models for knowledge distillation via a task-agnostic model. In example training methods, data augmentation may include generating synthetic data from the original data, e.g., using a generative model. For instance, a diffusion-based (e.g., semantic diffusion-based) data augmentation approach may be provided to extend the set of samples that distillation is applied to. Such an approach can lead to improved distillation results.

Example data augmentation approaches, for instance, may be based on or employ diffusion models such as but not limited to Stable Diffusion. Stable Diffusion models have been used for data augmentation, e.g., in the context of supervised learning, such as disclosed in Rombach et al., High-resolution image synthesis with latent diffusion models, In Proceedings of the IEEE/CVF Conference on Computer Vision and Pattern Recognition (CVPR), 2022; Saharia et al., Photorealistic text-to-image diffusion models with deep language understanding, In Advances in Neural Information Processing Systems (NeurIPS), 2022) in supervised learning (e.g., Trabucco et al., Effective data augmentation with diffusion models, arXiv preprint arXiv:2302.07944, 2023; Azizi et al., Synthetic data from diffusion models improves imagenet classification, Transactions on Machine Learning Research (TMLR), 2023; Dunlap et al., Diversify your vision datasets with automatic diffusion-based augmentation, In Advances in Neural Information Processing Systems (NeurIPS), 2024); and Zhou et al., Learning to prompt for vision-language models, International Journal of Computer Vision (IJCV), 130(9):2337-2348, 2022). Other generative models have been used in the art for replacing data (e.g., Sariyildiz et al., Fake it till you make it: Learning transferable representations from synthetic imagenet clones, In Proceedings of the IEEE/CVF Conference on Computer Vision and Pattern Recognition (CVPR), 2023).

Prior generative models for data augmentation typically use class names as textural prompts. However, designing prompts can be difficult for tasks such as segmentation, as it requires featuring the multiple classes found, e.g., in an image. Some disclosed methods have resorted to prompt engineering (e.g., Fang et al., Data augmentation for object detection via controllable diffusion models, In Proceedings of the IEEE Winter Conference on Applications of Computer Vision (WACV), 2024) or to language models to generate prompts from class names (e.g., Nguyen et al., Dataset diffusion: Diffusion-based synthetic dataset generation for pixel-level semantic segmentation, In Advances in Neural Information Processing Systems (NeurIPS), 2023; Zhou et al., Decoupled knowledge distillation, In Proceedings of the IEEE/CVF Conference on Computer Vision and Pattern Recognition (CVPR), 2022). However, unlike in such prior supervised learning examples where the generative model is typically conditioned by text prompts, e.g., with class labels, the dependence on class information becomes less certain when used for distillation, as labels are not required.

One alternative to methods such as text-to-image generation is to leverage image-to-image diffusion models to directly provide training images as prompts. Image-to-image diffusion models have been used for various tasks including restoration (e.g., Saharia et al., Palette: Image-to-image diffusion models, In Proceedings of the ACM SIGGRAPH Conference on Computer Graphics and Interactive Techniques, 2022a) or image editing (e.g., Brooks et al., Instructpix2pix: Learning to follow image editing instructions, In Proceedings of the IEEE/CVF Conference on Computer Vision and Pattern Recognition (CVPR), 2023).

However, using such models as a tool for data augmentation can present various challenges. For example, the models can struggle with producing meaningful variations such as viewpoint changes or object shape variations. While properties such as object shape, location, and appearance can be extracted and controlled from the internal representations of diffusion models (e.g., as disclosed in Epstein et al., Diffusion self-guidance for controllable image generation, In Advances in Neural Information Processing Systems (NeurIPS), 2023), this involves manual interventions and is not believed to have been universally applied to any task.

Example distillation methods herein can be improved by using a class-agnostic data augmentation. An example data augmentation can include generating synthetic data from original data using a generative model, such as a diffusion-based model. Example synthetic data generation may use a mixing approach, e.g., as provided in the synthetic data generation method 300. Example systems and methods herein can produce substantial image variations, such as by interpolating between multiple training images. Example interpolation methods can provide an approach that can be universally applied to any task.

Conventional data transformations, such as Mixup (e.g., as disclosed in Zhang et al., mixup: Beyond empirical risk minimization, In Proceedings of the International Conference on Learning Representations (ICLR), 2018, 2018) or CutMix, have been employed to provide simple photometric and geometric transformations for some knowledge distillation methods. For instance, Beyer et al., Knowledge distillation: A good teacher is patient and consistent, In Proceedings of the IEEE/CVF Conference on Computer Vision and Pattern Recognition (CVPR), 2022, discloses applying the same augmentations to the inputs of both teacher and student networks to ensure they are provided with consistent views. Wang et al., What makes a “good” data augmentation in knowledge distillation—a statistical perspective, In Advances in Neural Information Processing Systems (NeurIPS), 2022 suggests a data augmentation approach that reduces the covariance of the teacher-student cross-entropy, namely an enhanced CutMix augmentation. Stanton et al., Does knowledge distillation really work? In Advances in Neural Information Processing Systems (NeurIPS), 2021, discloses another approach using Mixup on knowledge distillation.

However, as opposed to simple photometric and geometric transformations such as standard Mixup or Cutmix, example systems and methods herein can perform data augmentation for use in distillation that can also exploit the richness of generative models, among other benefits. For knowledge distillation, the present inventors have recognized that data augmentation need not be constrained by the need for class labels or segmentation masks, and as a result, optimal data augmentation approaches may differ from those that have been disclosed for supervised learning.

For image data, for instance, example embodiments may use a data augmentation method including features of Mixup but configured to provide improved (e.g., more effective) data augmentation and (e.g., more efficient) distillation. Such example methods and systems can operate, e.g., solely, on unlabeled data images, obviating the need for text prompt engineering.

Example data augmentation methods, for instance, may use or be based on a variant of Stable Diffusion referred to as ImageMixer. J. Pinkney, Image mixer, Lambda Labs, 2022, discloses using ImageMixer for aesthetic purposes, namely generating visually appealing combinations of images. ImageMixer is a finetuned version of the method disclosed in Rombach et al., High-resolution image synthesis with latent diffusion models, In Proceedings of the IEEE/CVF Conference on Computer Vision and Pattern Recognition (CVPR), 2022, that enables the mixing of CLIP image representations from two or more input images to generate a new one. For example, CLIP embeddings can be concatenated along the sequence dimension and serve as a conditional input.

Example distillation methods herein can use such a method as a variant of standard Mixup methods for data augmentation, which involves mixing random pairs of images, regardless of their classes. This allows for the creation of an augmented or enhanced dataset [symbol] _{sd} containing both the original data, e.g., images, from [symbol] ₜᵣₐᵢₙ and the synthetic ones. For example, during training, an example method may use [symbol] _{sd} by randomly sampling synthetic images and original ones with equal frequency.

The original data [symbol] ₜᵣₐᵢₙ and/or the synthetic data may be further augmented during training, e.g., on the fly, using the data augmentation module 130. Additional data augmentation steps include but are not limited to classical or standard data augmentation. Such data augmentation steps can produce augmented data using the original data and/or the generated synthetic data, in any combination. Some example additional data augmentation steps may include steps based on a mixing approach. However, other data augmentation approaches may alternatively or additionally be used, for instance if a mixing approach was used to generate synthetic data in synthetic data generation step 302.

### Information Flow in Example Training Method

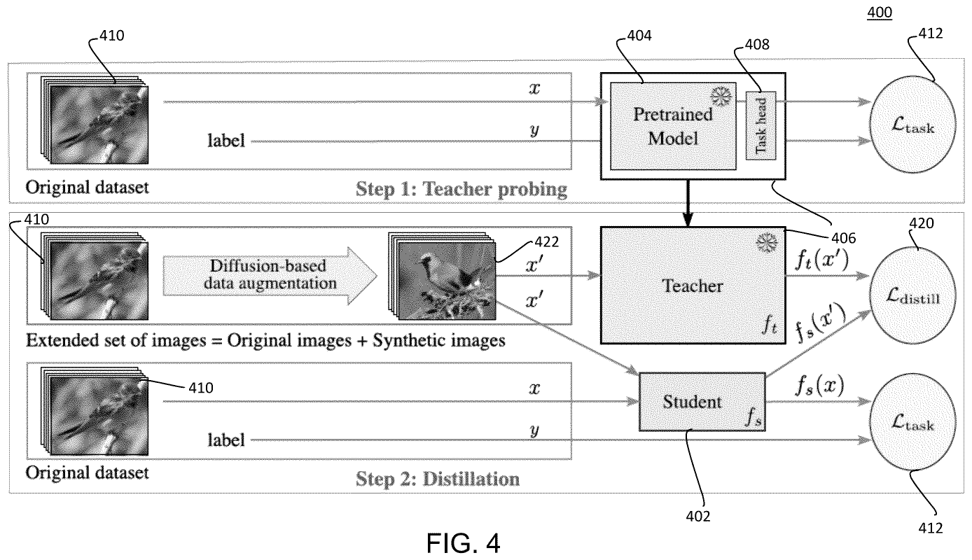

FIG. 4 shows an example information flow 400 in an example method for training a student 402, an example of the lightweight student network model 104, using a processor-based trainer such as training module 102. In a teacher probing stage (Step 1), a pretrained model 404, an example of large pretrained model 106, is probed to build a teacher 406. For instance, the pretrained model 404 may be frozen, and a task head 408 (an example of task head 110) may be connected to (e.g., downstream of) the pretrained model. Training data from an original dataset 410, e.g., a dataset of original images x having associated labels y, is input to the teacher 406, e.g., to the frozen pretrained model 404. During training, e.g., on the fly, the original dataset 410 may be transformed or augmented, e.g., using standard or classical data augmentation methods, for providing to the teacher 406. A task loss 412, e.g., a supervised task loss, is used for optimization, e.g., by optimizing trainable parameters of the task head 408.

In a subsequent knowledge distilling or distillation stage (Step 2), knowledge of the teacher 406 is distilled for training the student 402 by minimizing a distillation loss 420 jointly with a task loss, e.g., task loss 412. The distillation loss 420 can be optimized with both the original images x from the original dataset 410 and further with synthetic images in an extended dataset x′ 422, e.g., obtained via a generative model as provided herein. The original images x and/or the synthetic images x′ may also be transformed, e.g., using other data augmentation methods such as by task-agnostic data augmentation methods, standard or classical data augmentation methods, others, or a combination, during training, e.g., on the fly, for providing to the teacher 406 and the student 402.

On the other hand, during the example task stage, the task loss 412 preferably is optimized only on data from the original, labeled dataset (x,y) 410 (e.g., omitting the synthetic images x′), though the original dataset 410 may still be transformed or augmented, e.g., using standard or classical data augmentation methods, for providing to the student 402. Thus, in the example distillation stage, data from the extended data set 422 is used for the distillation loss [symbol] _{distill}, but not for the task loss [symbol] ₜₐₛₖ. While introducing synthetic data in the optimization of [symbol] ₜₐₛₖ can degrade performance, even for a variant that only mixes images of the same class, the generated images can be diverse enough to potentially extend beyond the scope of each class, while remaining close enough to the overall training domain to still be useful for distillation. However, it is also possible in other example methods to use the augmented dataset for the task loss, with the possibility of degraded performance.

### Inference

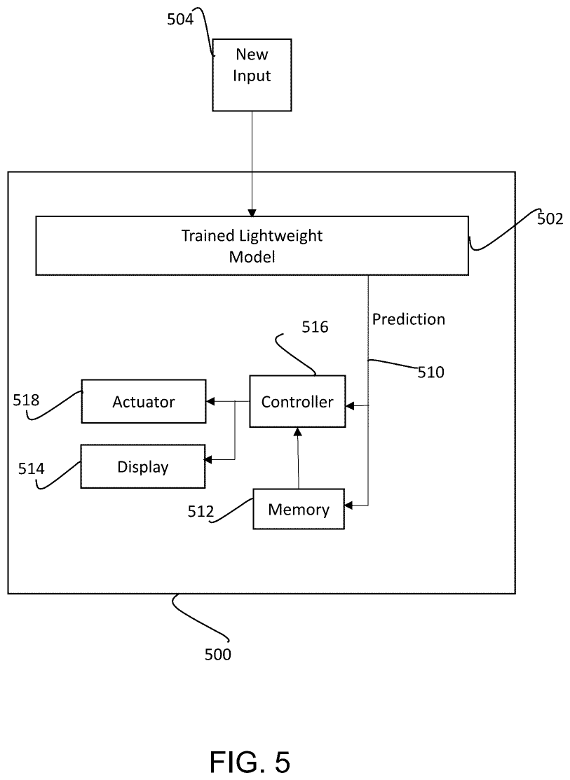

FIG. 5 illustrates a processor-based device 500 in which a trained (distilled) lightweight network model 502, an example of lightweight model 104, 402, may be implemented for performing a task, e.g., a prediction task, from a new input 504 during an inference method. The device 500 may be embodied in any suitable processor-based device, or combination of devices (e.g., multiple devices in a network) for receiving the new input 504, processing the new input using the trained lightweight network model 502 for performing the task to generate a prediction 510, and storing (e.g., in memory 512, which may be transitory or non-transitory depending on the performed operation), outputting (e.g., displaying via display 514 or providing for display on a display), and/or performing additional downstream tasks. An example processor-based device 500 may be, for instance, a computer or network of computers, a portable computing device, and/or other devices such as but not limited to an autonomous device (e.g., an autonomous vehicle, a drone, a mobile robot, or a robotic manipulator arm) which would receive the new input 504 from an input device such as a camera and perform a task for navigating or controlling the autonomous device (e.g., by classifying objects in an image received from the input device). The processor-based device 500 may also include, as nonlimiting examples, a controller 516 that can process the prediction and provide a control signal for the display 514, an actuator 518, or other components.

The trained lightweight network model 502, e.g., a neural network model that may be stored in or otherwise accessible to the device 500, may be trained via example distillation methods herein for performing a task such as image classification or a different task. The trained lightweight network model 502 may be, but need not be, further trained, fine-tuned, adapted, and/or combined with other models for performing one or more upstream or downstream tasks to provide a combined network or model, which may be implemented in the device 500.

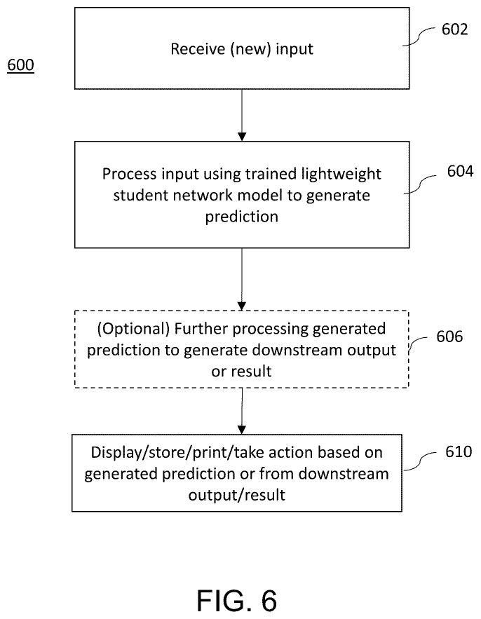

An example inference method 600 that may be performed by the trained lightweight network model 502 is illustrated in FIG. 6. The trained lightweight network model 502 receives at 602 a new input, such as new input 504. This new input may be, for instance, an image, which may be obtained, as nonlimiting examples, via an image capturing device (e.g., a camera or charge-coupled device (CCD)), via a wired or wireless network connection or interface from another device, from internal (e.g., memory 512) or external storage, by one or more input/output devices (keyboard, mouse, touch screen, stylus), etc. The new input 504 may be a single input or one of multiple new inputs. The new input 504 may be processed in any suitable manner before being input to the lightweight network model 502.

The trained lightweight network model 502 processes at 604 the received new input to generate a prediction (if the lightweight network model was trained for a prediction task) or other task output. For instance, for a specialized task such as an image classification task, the trained lightweight network model 502 in step 604 may receive one or more new images from any suitable image source and perform the classification task to generate a prediction, such as an image classification.

At 606, the result of the neural network processed task, such as a generated prediction, may optionally be further processed, e.g., by a processor in the device 500, to generate a downstream output or result. For example, the prediction may be combined or analyzed with other predictions, may be processed by one or more additional models, etc. At 610, the generated prediction from step 604 and/or any output from downstream processing from step 606 may be stored, output for further downstream tasks, used to generate a control signal for taking an action, provide an output for display on a display, etc.

If the device 500 is an autonomous device, for instance, then in response to an output prediction or downstream result the autonomous device may adapt its display, e.g., display 514, or other interface, and/or adapt its motion state (e.g., velocity or direction of motion) or other actuating operation. As a nonlimiting example, the controller 516 may be configured to control operation of the actuator 518, e.g., a propulsion device, to navigate the autonomous device to perform a downstream task based on the presence of generated motion of an entity (e.g., a human or robot) in an environment.

### Experiments

Experiments disclosed herein evaluated example distillation methods across three illustrative families of image-related tasks: classification on various domains, fine-grained classification, and semantic segmentation. For classification, experiments considered painting, sketch and clipart datasets from DomainNet (Peng et al., Moment matching for multi-source domain adaptation, In Proceedings of the International Conference on Computer Vision (ICCV), 2019), each composed of the same 345 classes, for which 20% of the training set was isolated for testing. Fine-grained classification was conducted on the CUB (Wah et al., Technical Report CNS-TR-2011-001, California Institute of Technology, 2011), FGVC Aircraft (Maji et al., Fine-grained visual classification of aircraft, Technical report, 2013) and DTD (Cimpoi et al., Describing textures in the wild, In Proceedings of the IEEE/CVF Conference on Computer Vision and Pattern Recognition (CVPR), 2014) datasets respectively consisting of 200 bird species, 100 aircraft models, and 47 textures.

Three benchmarks were used for segmentation: ADE20K (Zhou et al., Scene parsing through ade20k dataset, In Proceedings of the IEEE/CVF Conference on Computer Vision and Pattern Recognition (CVPR), 2017), Cityscapes (Cordts et al., The cityscapes dataset for semantic urban scene understanding, In Proceedings of the IEEE/CVF Conference on Computer Vision and Pattern Recognition (CVPR), 2016), and the augmented Pascal VOC (Everingham et al., The pascal visual object classes (voc) challenge, International Journal of Computer Vision (IJCV), 88(2):303-338, 2010).

### Backbone Models

To construct the example teacher model, an example method started from a backbone model provided by one of the pretrained transformer-based models provided by DINOv2 (Oquab et al., DINOv2: learning robust visual features without supervision, Transactions on Machine Learning Research (TMLR), 2024), either ViT-S, ViT-L or ViT-g, three architectures of increasing capacity. The ViT-L and ViT-S models provided by DINOv2 were distilled from their ViT-g. The teacher model was constructed according to an example method by probing one of these pretrained models for the target downstream task.

Experiments also considered a finetuned ViT-L teacher to investigate the impact of finetuning versus probing strategies for the teacher. Though the ViT-g model could also be finetuned, finetuning the ViT-L can be more suitable for maximizing the utility of pretrained models within constraints of limited computational resources.

For the example student network model, two lightweight architectures were considered. Most of the experiments used a ViT-S model initialized with DINOv2's pretrained weights. To consider whether results could be generalized to randomly initialized models, experiments were also conducted with a ResNet-50 model for classification and a DeepLabv3 model (Chen et al., Rethinking atrous convolution for semantic image segmentation, arXiv preprint arXiv:1706.05587, 2017) with ResNet-50 backbone for segmentation.

### Task Head

To provide the example task head (here, a prediction head), experiments used a multilayer perceptron (MLP) head for classification (unlike DINOv2 which evaluates with a linear head) and DINOv2's linear head for segmentation, for students and for teachers. There was no prediction head provided for the ResNet-50 and DeepLabv3 models, as those were trained from scratch.

When available, the input for the prediction head was defined as follows. In classification tasks, experimental methods adhere to DINOv2's process: i) CLS tokens from up to the last four blocks were concatenated (choosing four for DomainNet and three for fine-grained tasks); ii) optionally, the average pooling of the patch embeddings from the last block were concatenated (which was performed for DomainNet). For segmentation tasks, the experiments adopted DINOv2's linear evaluation protocol, directly evaluating from the patch embeddings of the last block.

For segmentation, the experiments used the same linear evaluation head as DINOv2's (Oquab et al., 2024). For classification, experiments used an MLP head, instead of a linear head as in DINOv2.

In the MLP head, nᵢₙ,n_{hidden},nₒᵤₜ respectively denoted the number of input, hidden, and output neurons. nₒᵤₜ is the number of classes, and nᵢₙ is the number of input features extracted from the pretrained backbone, meaning that nᵢₙ=n_{f}×(n_{CLS}+1_{use avgpool}), where:
n_{f} is the embedding dimension (n_{f}=1536, 1024, 384 for ViT-g, ViT-L, and ViT-S, respectively);
n_{CLS} is the number of blocks from which the CLS tokens are concatenated (n_{CLS}=4 for DomainNet, n_{CLS}=3 for fine-grained tasks);
1_{use avgpool} indicates whether one also concatenates the average pooling of the patch embeddings of the last block (true for DomainNet);

The number of hidden neurons n_{hidden} was set as n_{hidden}=nᵢₙ for ViT-S and n_{hidden}=\sqrt{nᵢₙ×nₒᵤₜ} for ViT-L/ViT-g, which in experiments provided the best results. Using such intermediate size for ViT-L/ViT-g, whose embedding sizes are larger (1024 and 1536) allowed for a more progressive decrease towards nₒᵤₜ.

### Synthetic Data Generation

The example synthetic data generation methods, based on Stable Diffusion, generated synthetic datasets with n times more images than the original training set, setting n to 5 for DomainNet and segmentation tasks, and to 10 for the relatively smaller fine-grained classification datasets. The example data augmentation approach used in experiments was based on a variant of Mixup (e.g., as disclosed in Zhang et al., mixup: Beyond empirical risk minimization, In Proceedings of the International Conference on Learning Representations (ICLR), 2018, 2018) as provided herein, akin to interpolating between random pairs of images using the ImageMixer method disclosed in J. Pinkney, 2022, in which CLIP embeddings were mixed through a diffusion model (Stable Diffusion). An example synthesis method adapted code for the ImageMixer method disclosed in Pinkney for synthesis with appropriate processing and sampling of the data.

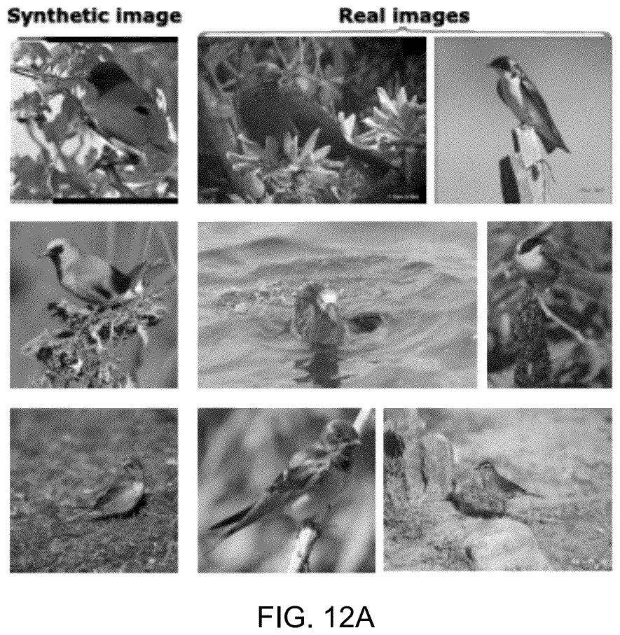

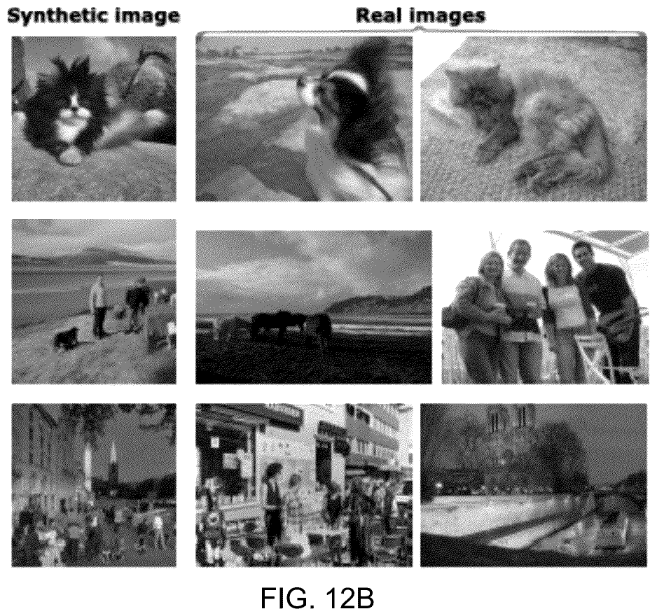

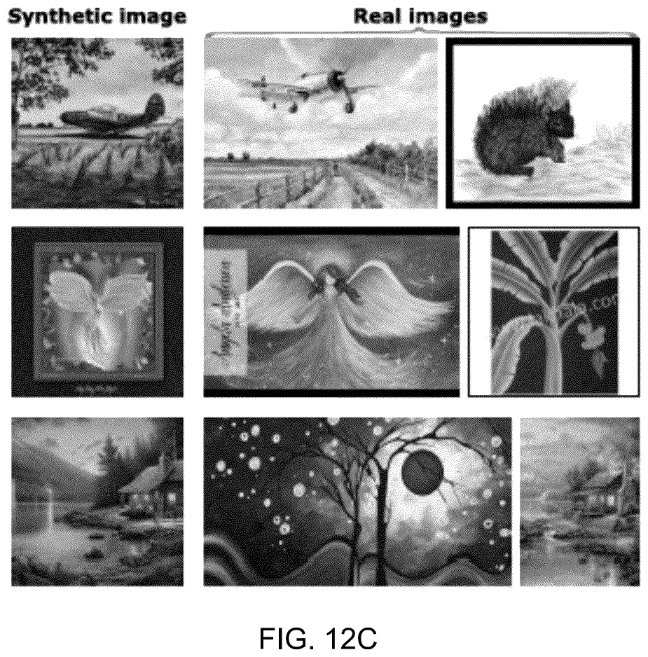

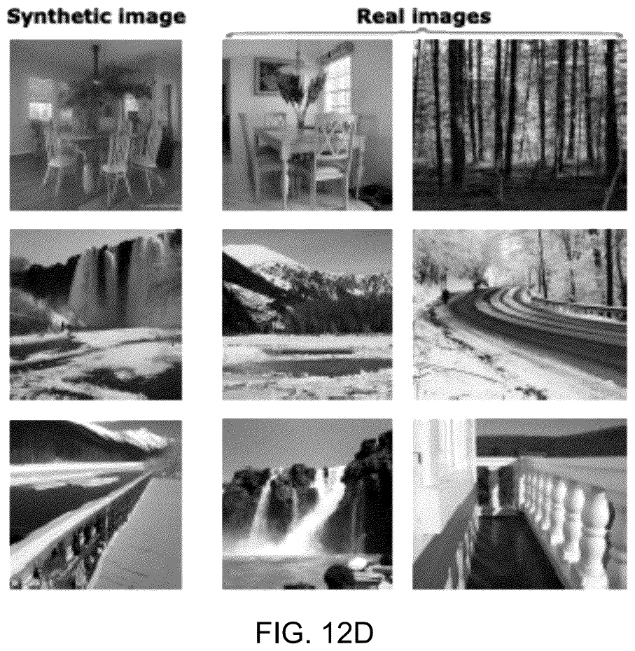

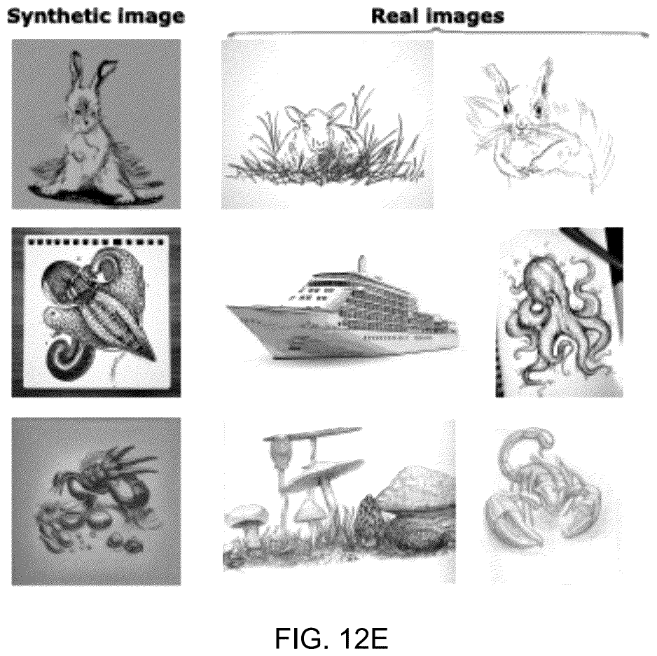

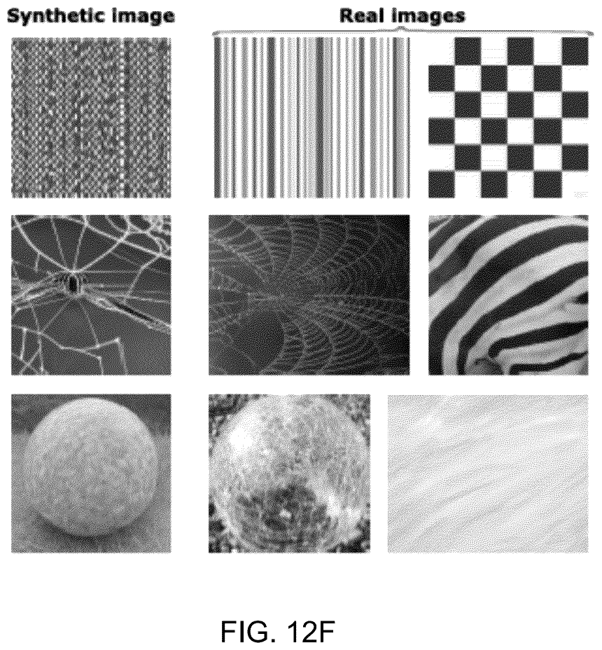

FIGS. 12A-12C show example synthetic images generated using ImageMixer, mixing two training images from CUB (e.g., as disclosed in Wah et al., Technical Report CNS-TR-2011-001, California Institute of Technology, 2011) (FIG. 12A), Pascal VOC (e.g., as disclosed in Everingham et al., The pascal visual object classes (voc) challenge, International Journal of Computer Vision (IJCV), 88(2):303-338, 2010) (FIG. 12B) and DomainNet's Painting (e.g., as disclosed in Peng et al., Moment matching for multi-source domain adaptation, In Proceedings of the International Conference on Computer Vision (ICCV), 2019) (FIG. 12C). These were used in the experiments to populate the extended dataset [symbol] _{sd} for distillation.

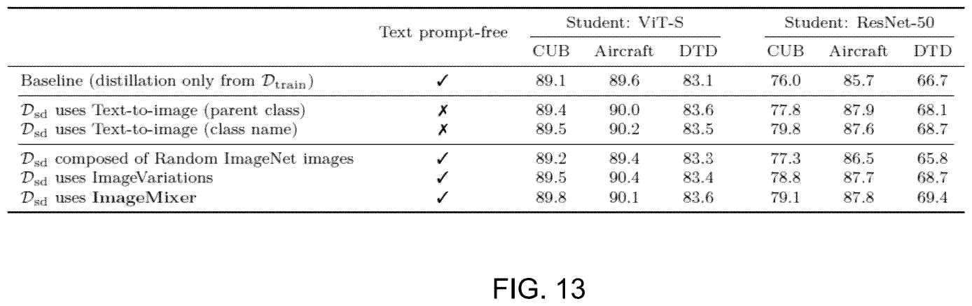

FIGS. 13A-13C shows examples of synthetic images generated using ImageMixer (J. Pinkney, 2022), mixing two training images from ADE20K (Zhou et al., Scene parsing through ade20k dataset, In Proceedings of the IEEE/CVF Conference on Computer Vision and Pattern Recognition (CVPR), 2017) (left), Sketch from DomainNet (Peng et al., Moment matching for multi-source domain adaptation, In Proceedings of the International Conference on Computer Vision (ICCV), 2019) (middle), and DTD (Cimpoi et al., Describing textures in the wild, In Proceedings of the IEEE/CVF Conference on Computer Vision and Pattern Recognition (CVPR), 2014) (right). These example synthetic images were also used in the experiments to populate the extended dataset [symbol] _{sd} used for distillation.

### Standard Data Augmentation

Methods used in experiments also applied classical data augmentation to both the original training images and to the generated synthetic images. For classification tasks involving transformers, experiments used RandomResizedCrop, ColorJitter, and Mixup, while for ResNet-50 experiments used TrivialAugment (Muller & Hutter, Trivialaugment: Tuning-free yet state-of-the-art data augmentation, In Proceedings of the International Conference on Computer Vision (ICCV), 2021). Mixup was excluded for synthetic images obtained from ImageMixer, which is already a variant of Mixup based on Stable Diffusion. For segmentation tasks, experiments adopted the same augmentations as DINOv2 (Oquab et al., 2024). In the experiments, the student and teacher models received exactly the same batch of images, transformed with the same data augmentation, as suggested in (Beyer et al., Knowledge distillation: A good teacher is patient and consistent, In Proceedings of the IEEE/CVF Conference on Computer Vision and Pattern Recognition (CVPR), 2022).

In all of the experiments, classical data augmentation was consistently applied to both training and to synthetic images, except for Mixup, which was only applied to original images. For training ViTs, the list of augmentations with their parameters for each tasks were set out below.
RandomResizedCrop with scale 0.08
ColorJitter with range (0, 0.4)
RandomFlip with probability 0.5
Mixup with parameter 0.2

For probing on fine-grained classification tasks, Resize and CenterCrop were simply applied instead of RandomResizedCrop, and Mixup was not applied, as in the experiments these transformations were too strong for fine-grained classification with a frozen backbone.

When training the ResNet-50, experiments used TrivialAugment's strategy (ImageNet version), similar to that disclosed in Muller & Hutter, Trivialaugment: Tuning-free yet state-of-the-art data augmentation, In Proceedings of the International Conference on ComputerVision (ICCV), 2021. This strategy included the following.
RandomResizedCrop with scale 0.08
ColorJitter with range (0, 0.4)
RandomFlip with probability 0.5
A fourth transformation randomly sampled among a pool.

For fine-grained classification, a scale parameter of 0.4 was used for RandomResizedCrop, as in the experiments 0.08 was too strong for training from scratch on fine-grained tasks.

For validation and testing, experiments followed a standard procedure of applying Resize and CenterCrop.

Semantic segmentation: Training was conducted with images of size (s, s) with s=560. The following data augmentations were applied for all experiments, which correspond to the mmsegmentation augmentations also used by DINOv2:
Resize to (., s) with ratio range (0.5, 2.0)
RandomCrop to (s, s), with cat_max_ratio=0.75
RandomFlip with probability 0.5
PhotoMetricDistortion.

For validation and testing, experiments used sliding windows of size (s, s) and stride s/2.

Table 1, below, shows the number of classes and the size (number of images) in the training set of the datasets used in experiments.

TABLE 1

| | | | Size |
|---|---|---|---|
| | | Classes | (train) |
| DomainNet(Peng | Painting | 345 | 60617 |
| et al., 2019) | Sketch | | 56304 |
| | Clipart | | 39064 |
| Fine-grained | CUB (Wah et al., 2011) | 260 | 5994 |
| classification | Aircraft (Maji et al., 2013) | 100 | 6667 |
| | DTD (Cimpoi et al., 2014) | 47 | 3760 |
| Semantic | ADE20K (Zhou et al., 2017) | 150 | 20210 |
| segmentation | Cityscapes (Cordts et al., 2016) | 19 | 2975 |
| | Pascal VOC (ang.) (Rearingham | 21 | 10582 |
| | et al., 2010) | | |

### Training Hyperparameters

Table 2 shows the weight decay and learning rate used for each task (classification on DomainNet, fine-grained classification, semantic segmentation), each architecture, and each training procedure (with/without freezing the pretrained backbone). Values were chosen based on a grid search of the validation set. Particularly, a coarse grid search was first performed on a logarithmic scale using powers of 10, before defining a finer one as shown in Table 2.

When the grid search led to values that were nearly identical for all tasks, the value was fixed to that shown on the table. Distillation with synthetic images using the example generative model (based on Stable Diffusion) was run with the best hyperparameters found for distillation without synthetic images. For finetuning experiments on ViT-L, a smaller batch size (8 for segmentation, 32 for classification) was used, and the learning rate in the grid search was reduced accordingly.

Table 2 shows training hyperparameters for a batch size of 128 for DomainNet and fine-grained classification tasks, and 16 for segmentation tasks (32 for probing). Hyperparameters shown in {⋅} were chosen based on a grid search on the validation set.

TABLE 2

| | Arch | | Learning rate | Weight decay |
|---|---|---|---|---|
| DomainNet | ViT | Probing | {.0001, .0002, .0004} | 0 |
| | | Finetuning/distillation | {1, 2, 4} × 10⁻ [symbol] | {.025, .05, .1} |
| | ResNet-50 | Training/distillation | .1 | .0005 |
| Fine-grained | ViT | Probing | {.001, .002, .004} | {.5, 1, 2, 4, 8} |
| classification | | Finetuning/distillation | {1, 2, 4} × 10⁻ [symbol] | {.025, .05, .1} |
| | ResNet-50 | Training/distillation | {.01, .02, .04} | {.005, [symbol] 01} |
| Semantic | ViT | Probing | .008 | 0 |
| segmentation | | Finetuning/distillation | {1, 2, 4} × 10⁻ [symbol] | {.001, .01, .1} |
| | DeepLabv3(R50) | Training/distillation | {.01, .02, 0.4, .08} | {.0001, .001, .01} |

[symbol]

indicates data missing or illegible when filed

### Training Time

Probing ran for 20 epochs for ViT-L/g and 30 epochs for ViT-S. Finetuning lasted for 50 epochs for ViT-L and 80 epochs for ViT-S. The AdamW optimizer was used for training ViTs and stochastic gradient descent (SGD) with momentum for ResNet-50, and a cosine scheduler in both cases. The selection of weight decay and learning rate was determined through a grid search on the validation set. In instances where no predefined validation set existed, 10% of the training set was allocated for this purpose. A fixed distillation temperature of T=2 and a constant weighting between the task loss [symbol] ₜₐₛₖ and the distillation loss [symbol] _{distill} of α=0.5 were set for all experiments.

All experiments were performed on a single GPU (either V100 or A100). For illustration, training time herein is detailed for a pretrained ViT-g as teacher and a pretrained ViT-S as student. When using a ResNet-50 from scratch as student, the training time per epoch is similar to that of the ViT-S, but training is longer (200 epochs instead of 80). It was observed in experiments that probing the teacher (ViT-g) either took less time or about the same amount of time as finetuning the student (ViT-S). Distillation with the probed ViT-g as teacher took approximately twice as long as finetuning. Adding data augmentation based on Stable Diffusion (the experimental generative model) further increased the training time by 1.5 times on average. For example, finetuning the ViT-S for ADE20K took 16 hours on an A100 GPU, while distillation with data augmentation based on Stable Diffusion took 55 hours, and probing the ViT-g took 14 hours.

For generation of synthetic data in experiments, the example image mixing procedure took approximately 2 hours for 1000 images (on a V100 GPU). Synthetic datasets were generated with n times more images that n in the training set, with n=5 for DomainNet and semantic segmentation, and n=10 for the relatively smaller fine-grained tasks. Table 3, below, shows the size of the training set of each task.

TABLE 3

| | | | Size |
|---|---|---|---|
| | | Classes | (train) |
| DomainNet(Peng | Painting | 345 | 60617 |
| et al., 2019) | Sketch | | 56304 |
| | Clipart | | 39064 |
| Fine-grained | CUB (Wah et al., 2011) | 260 | 5994 |
| classification | Aircraft (Maji et al., 2013) | 100 | 6667 |
| | DTD (Cimpoi et al., 2014) | 47 | 3760 |
| Semantic | ADE20K (Zhou et al., 2017) | 150 | 20210 |
| segmentation | Cityscapes (Cordts et al., 2016) | 19 | 2975 |
| | Pascal VOC (ang.) (Rearingham | 21 | 10582 |
| | et al., 2010) | | |

### Evaluation

Results were averaged over three independent runs with different random seeds. For distillation evaluations, three different teachers were considered, each from independent runs. Two runs per teacher were conducted for DomainNet and three runs for fine-grained and segmentation tasks.

Regarding probing results, for classification, a MLP head was used in example methods, while DINOv2 uses a linear head. Additionally, for segmentation, example methods used an image size of 560×560 pixels while DINOv2 used 512×512. This provided probing results that were slightly higher than those reported by Oquab et al., 2024.

### Results

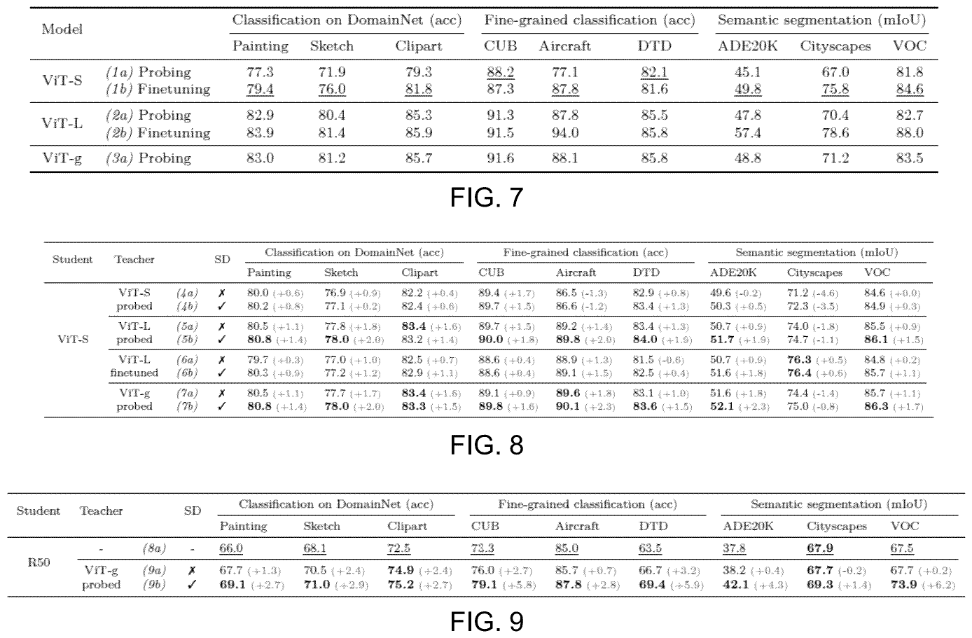

Distillation was considered with two different students: i) DINOv2's ViT-S pretrained with task-agnostic distillation, and ii) randomly initialized models: a ResNet-50 for classification and a DeepLabv3 with ResNet-50 backbone for segmentation. Results are shown in FIGS. 7-9. FIG. 7 shows example probing and finetuning results of DINOv2 ViT-S, ViT-L, and ViT-g pretrained models for classification on DomainNet, fine-grained classification, and semantic segmentation. FIG. 8 shows distillation results using ViT-S as the student, and using a probed ViT-S, a probed and a finetuned ViT-L, or a probed ViT-g as the teacher. FIG. 9 shows distillation results using a probed ViT-g as the teacher, and a randomly initialized ResNet-50 as the student. The distillation results in FIGS. 8-9, both with and without augmenting the training set with synthetic images for distillation, were compared to those obtained with a simple probing or finetuning of the ViT-s (best results are underlined in FIG. 7) and with simple training of ResNet-50 (underlined in FIG. 9), with relative gains indicated in parentheses.

The results shown in FIGS. 7-9 were considered based on the relative gains of distillation over finetuning when teaching a small pretrained model; the impact of finetuning the teacher; the impact of using a teacher that is less accurate than the student; and generalization to students trained from scratch. Observations are presented by comparing lines of FIGS. 7-9. The lines from these three tables are denoted by unique alphanumerical reference such that, e.g., 2a-2b refers to comparing lines 2a and 2b in FIG. 7.

### Task-Specific Distillation as Complement to Task-Agnostic Distillation

The results shown in FIG. 8 demonstrate that task-specific distillation according to example methods generally outperformed probing and finetuning. This can be observed, for instance, by comparing any line from FIG. 8, 4 to 7, a or b, with the corresponding number in line 1 from FIG. 7, referred to as 4-7 vs 1, following the notation introduced above previous paragraph.

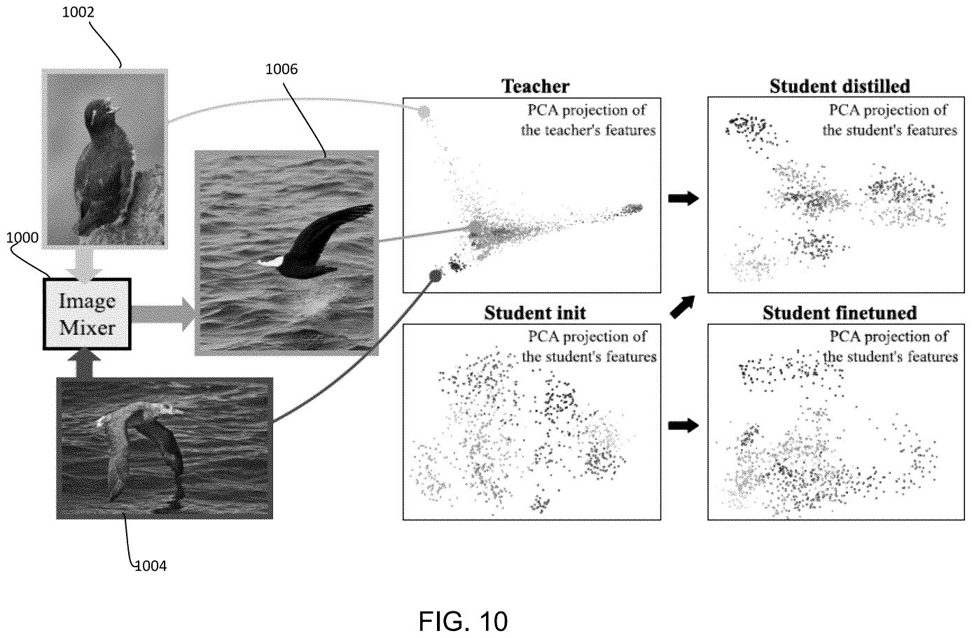

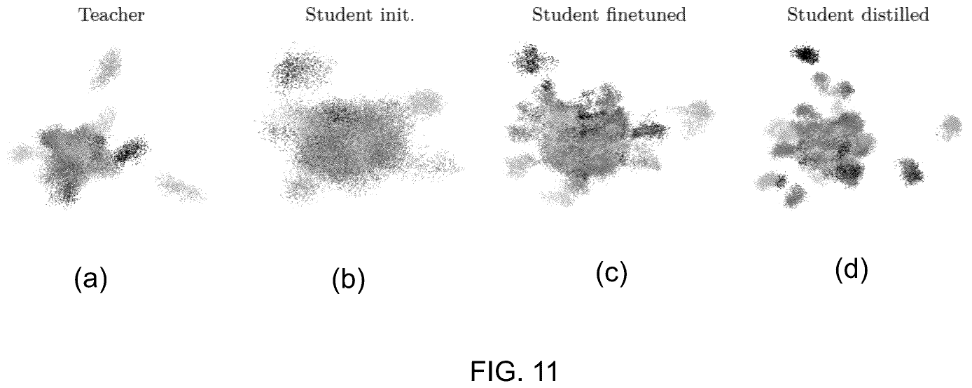

FIGS. 10 and 11 show example PCA-based visualizations of the learned representations for CUB and ADE20K datasets, respectively. A large pretrained teacher (top, left) was distilled to train a small task-specific student model (top, right). An example image generator 1000, e.g., based on Stable Diffusion, mixed real images 1002, 1004 to create synthetic images 1006, producing features shown in gray in the teacher plot in FIG. 10. In FIG. 10, each plot shows image features for 30 classes of the CUB Bird dataset, after principal component analysis (PCA) (one color per class).

FIG. 11 shows a principal component analysis (PCA) of patch embedding representations for 20 classes of ADE20K for a ViT-g teacher (a) and for the ViT-S student in its initial state (b), after finetuning (c) and after distillation (d), colored by their main class, illustrating that classes are better clustered after distillation than after finetuning.

The method used for constructing the example PCA visualizations in the experiments will now be described.

For the PCA visualization of teacher predictions from FIG. 10 on the CUB fine-grained classification task, steps included:
1. Feature computation: for both original and synthetic CUB training images, feature computation gave class token predictions of shapes (N, D) and (N_{synthetic}, D), with D the embedding dimension (D=1536 for ViT-g and D=384 for ViT-S).
2. Subsampling: only the first 20 classes were kept. Synthetic images were kept that resulted from a mix of images belonging to this set of 20 classes. This leaves M<N and M_{synthetic}<N_{synthetic} images.
3. PCA: PCA was conducted over the (M, D) predictions on original images.
4. Visualization: visualization of the (M+M_{synthetic}, D) data points were projected onto the two main principal components, colored by the class label for the M images, and in gray for the M_{synthetic} images.

For the visualization of student predictions on FIG. 10, the steps were the same but without the synthetic images.

For the PCA visualizations from FIG. 11 on the ADE20K segmentation task, patch embedding representations were visualized as follows:
1. Feature computation: feature computation on N=500 test images were performed, providing patch embedding predictions of shape (N, D, H, W) with D the embedding dimension, and

$$H = W = 40 ( = \frac{image size}{patch size} = \frac{560}{14} ) .$$

2. Resizing: resizing of the corresponding 500 segmentation maps was performed to shape (N, C, H, W), where C was the number of classes. The visualization used mmsegmentation's resize method on one-hot encoded labels.
3. Flattening: predictions and labels were flattened to (N×H×W, D), (N×H×W, C) respectively.
4. Filtering: patches were retained whose labels were well defined, with a probability over 0.9.
5. Subsampling: only 20 classes were kept. Selected classes were those whose size (number of patches of this class) were closest to the median size.
6. Data points: filtering and subsampling yielded a number M of data points, where M<N×H×W.
7. PCA: PCA was performed on the (M, D) predictions.
8. Visualization: Visualization was performed.

As illustrated in FIG. 10, the example distillation process resulted in an improved clustering of the representations (illustrated here by PCA projection of the student's features) compared to simply finetuning the student on the task (bottom, right). As further shown in FIG. 11, the PCA of patch embedding representations exhibited a better clustering structure after distillation than after finetuning.

Cityscapes was the only exception where distillation from a probed ViT-L or a probed ViT-g did not improve over finetuning. On Cityscapes, the finetuned ViT-S student already outperformed the probed ViT-g and ViT-L teachers by a large margin (+4.6 and +5.4 mIoU) (1b vs 3a, 2a), which may explain why distilling from those was not beneficial in this example.

The example dataset augmentation based on Stable Diffusion further enhanced distillation results (4a vs 4b, 5a vs 5b, etc.), except on Clipart. In Clipart, the example dataset augmentation performed on par with distillation on the original training images alone.

While ViT-g exhibited slightly higher accuracy than ViT-L when probed on downstream tasks (3a vs 2a), both models provided almost equally effective teachers for distillation (7 vs 5). In exploring experiments with smaller teachers, distillation was evaluated from a probed ViT-S(1a), providing the context of self-distillation. It was observed that when the performance gap between probing and finetuning was not too large, self-distillation (4) improved over finetuning (1b), evident across all baselines except for Aircraft and Cityscapes, where the probed ViT-S had an accuracy/mIoU approximately 10% lower than with finetuning (1a vs 1b). However, ViT-g and ViT-L remained superior teachers compared to ViT-S. This suggests that, even if ViT-S was pretrained with generic distillation from ViT-g, it is more effective to directly leverage the largest teachers for downstream tasks.

### Finetuning Vs Probing for Yielding Teachers

Example methods can exploit the observation that at comparable performance (in experiments, a difference in accuracies smaller than 6% for the three families of models considered here, DINOv2, EVA-02 and EVA-02-CLIP), a probed model can make a better teacher than a finetuned one. By contrast, performing finetuning can result in catastrophic forgetting.

The impact of finetuning the teacher prior to distillation was assessed in experiments. Distillation results were compared using either a probed or finetuned pretrained ViT-L model from DINOv2 (Oquab et al., 2024). Finetuning significantly enhanced ViT-L's accuracy compared to probing (2a vs 2b). However, employing the finetuned ViT-L model as a teacher generally resulted in a poorer performance for the student (5 vs 6). For example, finetuning resulted in approximately 6% increase in accuracy for Aircraft and Pascal VOC compared to probing (2a vs 2b), yet the distillation results with the probed teacher were better (5 vs 6).

This demonstrates benefits of preserving the rich representations learned during pretraining, even if this leads to a teacher with lower accuracy for the specific task. Although in the experimental results for Cityscapes distillation of a finetuned teacher significantly improved results compared to using a probed teacher (5 vs 6), this may be attributable to the substantial performance gap between probing and finetuning on the dataset used in the experiments, with +8 to +9 in mIoU (1a vs 1b, 2a vs 2b).

It was observed that, when specializing for a given task, the finetuned teacher had forgotten some features that were not immediately relevant for optimizing the task loss, but that still helped generalization. In experiments, when finetuned on the CUB bird classification task, the pretrained model could end up only relying on spurious correlations (such as the background, a standard source of spurious correlations in CUB) that provided shortcuts to the optimization. These shortcuts helped improve the teacher accuracy but were detrimental to the distillation process. Thus, a probed model in example methods herein can serve as a better teacher than a finetuned one, since in the latter instance aspects of the representation that are still relevant to the task are lost when training for that task.

In general, the experiments demonstrated that finetuning a teacher for task-specific distillation can be unnecessary and even detrimental. Example methods herein instead can exploit the relatively fast training of a task head (e.g., MLP head), so that the primary computational cost in knowledge distillation with teacher probing can lie in training the student, with the additional overhead of performing forward passes through the teacher.

### Accuracy of Teachers and Students

The most accurate teachers may not always be the best for example distillation methods. This may be, for instance, due to the model capacity gap between the student and the teacher.

To optimize use of the largest models, Mirzadeh et al., Improved knowledge distillation via teacher assistant, In Proceedings of the AAAI Conference on Artificial Intelligence, 2020, discloses a multi-stage approach where knowledge is distilled from a large model to successively smaller ones, thus reducing the capacity gap between two successive distillation steps. By contrast, Cho & Hariharan, On the efficacy of knowledge distillation, In Proceedings of the International Conference on Computer Vision (ICCV), 2019, discloses that such an approach is inefficient, and that this capacity gap can be mitigated by stopping the teacher's training early.

Example systems and methods herein instead freeze the teacher's pretrained backbone, thus probing the model instead of finetuning it. This can prevent the model from specializing too much to the given task, and can result in improved distillation despite a lower teacher accuracy. Even with a large capacity gap, example methods can obtain good results, e.g., by distilling directly from a pretrained model, such as DINOv2's largest ViT-g model, to much smaller models, such as ViT-S or ResNet-50.

In several experiments, simply finetuning the ViT-S model (1b) provided better results than probing ViT-g (3a), including for all three segmentation tasks. Still, distilling from ViT-g was beneficial for ADE20K and Pascal VOC (7b), as it provided around 2% mIoU gain compared to finetuning (1b), even though the finetuned ViT-S model was already about 1% higher in mIoU than the teacher (3a). This further demonstrates that the student can surpass its teacher and still benefit from distillation in example methods.

In example methods herein, the student models can learn from poorly trained teachers, or from teachers with the same architecture, and can even outperform them. The experiments demonstrated that a small model can benefit from distillation even when that same model already outperforms its larger teacher after simple finetuning. Distillation also resulted in improvements when using a teacher of the same size as the student (self-distillation), though distilling from the largest models may provide improvements over self-distillation, as knowledge from larger models can further guide the training of a smaller student.

### Effect of Data Augmentation Methods on Various Students

To consider the effect of example data augmentation methods herein on additional students, experiments replaced DINOv2's pretrained ViT-S student with a ResNet-50 (resp. DeepLabv3 with a ResNet-50 backbone for segmentation) trained from scratch, while retaining DINOv2's pretrained ViT-g as the teacher. The results shown in FIG. 9 demonstrated that distillation was consistently beneficial, directly leading to 2% accuracy gain on average. Significantly, example data augmentation methods based on Stable Diffusion significantly enhanced results, yielding a further 2-3% accuracy gain on fine-grained tasks and a 4-6% mIoU gain for segmentation compared to standard distillation (9a vs 9b). Surprisingly, the ResNet-50 model benefited even more from distillation than the pretrained ViT-S model.

These results suggest that beneficial results for a pretrained ViT-S student can further generalize to students even that i) did not undergo generic distillation or any form of pretraining, and ii) whose architecture is not based on transformers like the teacher. Example data augmentation methods herein can substantially help even students trained from scratch.

### Data Augmentation Approaches

Additional experiments compared various strategies for creating an augmented dataset [symbol] _{sd} use or distillation. The comparisons focused on fine-grained classification tasks, involving both a pretrained ViT-S and a ResNet-50 trained from scratch as students. A data augmentation strategy according to example methods based on Stable Diffusion leveraging a model from ImageMixer (J. Pinkney, 2022) was compared to: i) another model disclosed in J. Pinkney, 2022, ImageVariations, which creates image variations from single images; ii) an augmentation approach incorporating (simply adding) an ImageNet subset; and iii) a text-to-image diffusion model used by Sariyildiz et al., Fake it till you make it: Learning transferable representations from synthetic imagenet clones, In Proceedings of the IEEE/CVF Conference on Computer Vision and Pattern Recognition (CVPR), 2023. For the latter, experiments explored textual prompts with the parent class, and with and without class names. In the experiments, prompts with class names took the form “A photo of a {class name}{parent class}” while prompts without class names followed the pattern “A photo of a {parent class}”, where {parent class}represented either bird, aircraft, or texture.

FIG. 13 shows experimental results demonstrating that an example data augmentation according to methods herein, which was prompt-free, performed equally well, if not better, than a prompt-based data augmentation that leveraged class information. Additionally, prompt engineering poses challenges for certain tasks, such as segmentation, and it necessitates the model used for parsing prompts (e.g., CLIP) to be trained with semantic information about the data. This may be impossible for some modalities such as but not limited to medical or microscopy images, which are not easily described with text and might fall outside the semantic scope expected by CLIP-like models. Example data augmentations herein based on synthetic images produced using the ImageMixer model outperformed the ImageVariations model on five out of six settings. This demonstrates benefits of a mixing-based approach conditioning image generation with multiple images.

### Using Augmented Data for Supervision

The above experiments used synthetic data only for optimizing the distillation loss [symbol] _{distill} while the task-specific loss [symbol] ₜₐₛₖ was trained solely on real data. Additional experiments considered the result when incorporating synthetic images as additional labeled data for optimizing [symbol] ₜᵣₐᵢₙ for both finetuning and distillation. Experiments compared two different ways of leveraging the diffusion model disclosed in J. Pinkney, 2022, namely mixing images regardless of their labels (inter-class), or mixing images from each class separately (intra-class). These approaches resulted in two augmented datasets, [symbol] _{sd} and [symbol] _{sd-intra}, containing both the original images and the synthetic ones, as explained above.

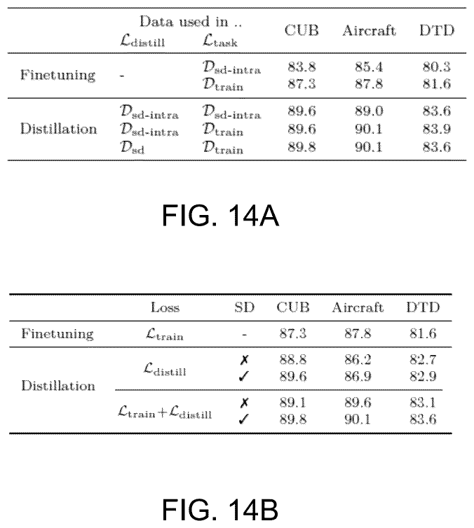

FIG. 14A shows distillation results for the fine-grained datasets, illustrating the impact of synthetic data on experimental distillation and task losses, including an impact on fine-grained classification tasks for finetuning and distillation with ViT-S as student and ViT-g as teacher, using a dataset [symbol] _{sd-intra} augmented with synthetic images by mixing original images inside each class separately. Comparable performance was observed between inter-class and intra-class approaches, though incorporating synthetic data for supervision was not beneficial. Including these synthetic images in the optimization of the task-specific loss [symbol] ₜₐₛₖ degraded results, particularly for finetuning, which suggests that the diffusion model may not be faithful enough to each fine-grained class. Use of synthetic images may be more beneficial where i) the generation process is sufficient enough for images to pertain to their class, which may be challenging for fine-grained tasks, and ii) the generation process can create the right label for each new image, which is challenging for dense tasks such as semantic segmentation.

In general, in contrast to using synthetic image-label pairs for supervised learning, example methods herein using generative models to generate synthetic data for knowledge distillation can alleviate the need for generating class-specific images and for labeling generated images.

### Relative Weighting Between Task and Distillation Losses

For additional models, the loss [symbol] ₜₐₛₖ was omitted during distillation. FIG. 14B illustrates an example role of different finetuning and distillation losses, including a comparison of fine-grained classification when solely optimizing [symbol] ₜᵣₐᵢₙ (finetuning), solely optimizing [symbol] _{distil}, and optimizing both with equal weights. Training without label information (optimizing [symbol] _{distill} only) yielded competitive results for CUB but significantly lower results for Aircraft. Overall, the student achieved the best results when exposed to both hard labels and soft teacher labels.

### Benefits

Training systems and methods provided herein can provide various features and benefits. For example, instead of finetuning a teacher as is performed in conventional task-specific distillation methods, example training systems and methods herein can exploit the adaptability of large-scale pretrained models for probing, yielding better teachers.

Further, as task-specific distillation allows transferring task-specific knowledge, example systems and methods using task-specific distillation can complement task-agnostic distillation, leading to improved representations, e.g., compared to simply finetuning the student after task-agnostic distillation. Task-specific distillation surprisingly can consistently outperform simple finetuning even when teachers are only probed for the task. This benefit can reduce the cost of example distillation methods.

Example diffusion models can be effectively leveraged as data augmentation for distillation without relying on class information. In image processing, for instance, this makes such diffusion models applicable even to tasks where text-conditioned image generation is non-trivial, such as but not limited to semantic segmentation. By leveraging a diffusion model that generates mixed images conditionally on multiple images provided as input, example methods can avoid the need for class information for such generative models, while consistently helping task-specific distillation.

Example systems and methods can provide beneficial distillation even when a pretrained student outperforms (e.g., is more accurate than) its teacher. Further, example systems and methods can allow small models to directly learn even from much larger ones. This is a surprising result, as it has been believed that a large capacity gap between teacher and student hinders distillation, and accordingly in some prior distillation methods a middle-sized ‘teacher assistant’ has been employed to learn from the large model and teach the smaller one. The experiments using example training methods demonstrate that task-specific distillation can work well when using either large or middle-size teacher models to directly teach a small student model.

### Network Architecture

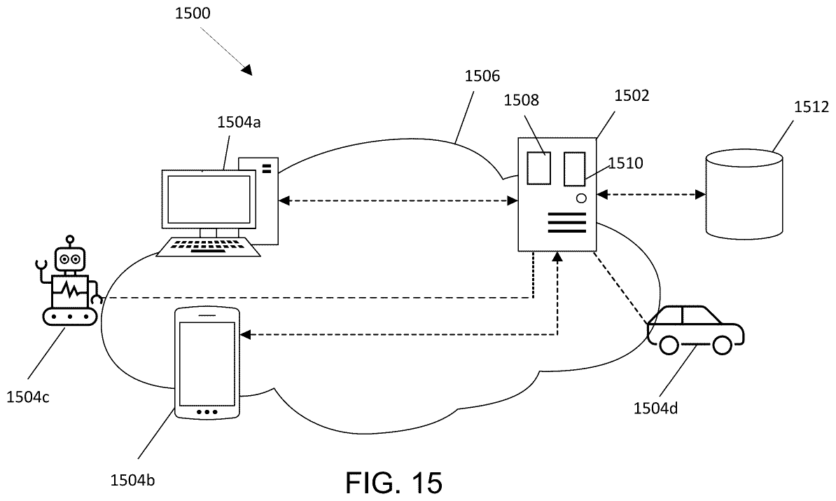

Example systems, methods, and embodiments may be implemented within a network architecture 1500 such as illustrated in FIG. 15, which may include a server 1502 and one or more client devices 1504 that communicate over a network 1506 which may be wireless and/or wired, such as the Internet, for data exchange. The server 1502 and the client devices 1504a, 1504b can each include a processor, e.g., processor 1508 and a memory, e.g., memory 1510 (shown by example in server 1502), such as but not limited to random-access memory (RAM), read-only memory (ROM), hard disks, solid state disks, or other non-volatile storage media. Memory 1510 may also be provided in whole or in part by external storage in communication with the processor 1508. The server 1502, for example, may be embodied in one or more computers. Reference herein to “computer” or “a computer” is intended to refer to one or more computers, and reference to “processor” or “a processor” is intended to refer to one or more processors.

The task-specific distillation architecture 100 for training a lightweight student network model (lightweight model) 104 may be embodied in the server 1502 and/or client devices 1504. Similarly, the lightweight model 104 may be embodied in the server 1502 and/or client devices 1504. The lightweight model 104, for instance after training according to example distillation methods herein, may be, but need not be, implemented into devices 1504 or portions of devices where it may be less practical or even infeasible to implement a significantly larger model, e.g., due to storage constraints, resource constraints, energy efficiency constraints, time constraints, etc. The large pretrained model 106 and/or the lightweight model 104 may be embodied in respective neural network model models. The lightweight model 104 may be trained using example methods herein for performing any applicable task (including but not limited to image processing tasks, such as described herein).

It will be appreciated that the processor 1508 can include either a single processor or multiple processors operating in series or in parallel, and that the memory 1510 can include one or more memories, including combinations of memory types and/or locations. Server 1502 may also include, but are not limited to, dedicated servers, cloud-based servers, or a combination (e.g., shared). Storage, e.g., a database, may be embodied in suitable storage in the server 1502, client device 1504, a connected remote storage 1512 (shown in connection with the server 1502, but can likewise be connected to client devices), or any combination.

Client devices 1504 may be any processor-based device, terminal, etc., and/or may be embodied in a client application executable by a processor-based device, etc. Client devices may be disposed within the server 1502 and/or external to the server (local or remote, or any combination) and in communication with the server. Example client devices 1504 include, but are not limited to, autonomous computers 1504a, mobile communication devices (e.g., smartphones, tablet computers, etc.) 1504b, robots 1504c, autonomous vehicles 1504d, wearable devices, virtual reality, augmented reality, or mixed reality devices (not shown), or others. Client devices 1504 may be configured for sending data to and/or receiving data from the server 1502, and may include, but need not include, one or more output devices, such as but not limited to displays, printers, etc. for displaying or printing results of certain methods that are provided for display by the server. Client devices may include combinations of client devices.

In example training methods, including the probing stage and the distillation stage, the server 1502 and/or client devices 1504 may receive a dataset, e.g., an original dataset, from any suitable source, e.g., from memory 1510 (as nonlimiting examples, internal storage, an internal database, etc.), from external (e.g., remote) storage 1512 connected locally or over the network 1506. In the probing stage, the example training module 102 can receive the dataset and perform steps including augmenting a large pretrained model with a task head to construct a teacher model, and probing the teacher model using the received dataset over a task objective to provide a probed teacher model. In example extended data generation methods, the server 1502 and/or client devices may receive the dataset and generate the extended dataset. In the distillation stage, the probed teacher model can be coupled to the lightweight model via any suitable connection, including within a common server 1502 or client device 1504, directly, over the network 1506, or any combination. The original dataset, the synthetic dataset, the training module, the probed teacher model, and the lightweight model may respectively be stored together on one or more common servers 1502 or client devices 1504, or may each be stored separately, in any combination. The training module 102 may perform, or cause to be performed, one or more of the steps in example training methods, including steps in the probing stage and/or distillation stage.

The probed teacher model and/or trained lightweight model e.g., including or represented by a neural network model with model parameters, may be stored in the server (e.g., memory 1510), client devices 1504, external storage 1512, or combination. In some example embodiments provided herein, probing of the teacher model, distillation training of lightweight model, and/or inference by the trained lightweight model (e.g., in performance of a task such as an image classification task) may be performed offline or online (e.g., at run time), in any combination. Results can be output (e.g., displayed, transmitted, provided for display, printed, etc.) and/or stored for retrieving and providing on request.

If the trained task is an image processing task, for instance, one or more of the server 1502 or client devices 1504 may be provided with one or more imaging devices (CCDs, energy sensors, cameras, etc.) for directly or indirectly receiving new images (or image signals) of various origins and types for processing by the trained lightweight models. The image signals can be received locally or remotely, either directly or via a suitable interface, or from another of the server or client devices connected locally or over the network 1506. Results, e.g., predictions, from the trained lightweight model's processing of the new input to perform a task can be directly or indirectly (e.g., via one or more downstream tasks or operations) output (e.g., displayed, transmitted, provided for display, printed, etc.), used for controlling one or more devices, and/or stored for retrieving and providing on request.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

### General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. All documents referred to herein are incorporated herein by reference in their entirety, without any admission that such documents constitute prior art.

It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between features (e.g., between modules, circuit elements, semiconductor layers, etc.) may be described using various terms, such as “connected,” “engaged,” “coupled,” “adjacent,” “next to,” “on top of,” “above,” “below,” “disposed”, and similar terms. Unless explicitly described as being “direct,” when a relationship between first and second features is described in the disclosure herein, the relationship can be a direct relationship where no other intervening features are present between the first and second features, or can be an indirect relationship where one or more intervening features are present, either spatially or functionally, between the first and second features, where practicable. As used herein, the phrase “at least one of” A, B, and C or the phrase “at least one of” A, B, or C, should be construed to mean a logical (A OR B OR C), using a non-exclusive logical OR, and should not be construed to mean “at least one of A, at least one of B, and at least one of C.”

In the figures, the direction of an arrow, as indicated by an arrowhead, generally demonstrates an example flow of information, such as data or instructions, that is of interest to the illustration. A unidirectional arrow between features does not imply that no other information may be transmitted between features in the opposite direction.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A computer-implemented method for training a lightweight student network model for performing a task, the method comprising:
augmenting a pretrained network model with a task-specific prediction head to provide a teacher model, the pretrained network model being larger than the lightweight student network model;
training the teacher model on the task, said training the teacher model using a task objective;
training the lightweight student network model jointly using at least the task objective and a distillation objective, the distillation objective comprising a similarity between predictions from the lightweight student model and predictions from the trained teacher model; and
storing the trained lightweight student network model.

2. The method of claim 1, wherein the pretrained network model includes pretrained network model parameters, the task-specific prediction head includes task-specific prediction head parameters, and the lightweight student network model includes lightweight student network model parameters.

3. The method of claim 2, further comprising:
before said training the teacher model, initializing the pretrained network model parameters; and/or
before said training the teacher model, pretraining the pretrained network model, wherein said pretraining is self-supervised.

4. The method of claim 2, further comprising:
initializing the lightweight student network model parameters.

5. The method of claim 2, further comprising;
pretraining the lightweight student network model parameters with a task-agnostic distillation.

6. The method of claim 1, wherein the task objective is supervised.

7. The method of claim 2, wherein said training the teacher model comprises:
freezing all or a subset of the pretrained network model parameters; and
optimizing the task-specific prediction head parameters.

8. The method of claim 7, wherein said training the lightweight student network model comprises:
freezing all of a subset of the trained teacher model including the pretrained network model parameters and the task-specific prediction head parameters.

9. The method of claim 1, wherein the task-specific prediction head comprises one or more of:
a multilayer perceptron; or
a convolutional layer.

10. The method of claim 1, wherein the task-specific prediction head comprises a linear layer.

11. The method of claim 8, wherein training the lightweight student network model further uses a weighting parameter for the distillation objective and/or the task objective.

12. The method of claim 1, wherein the distillation objective comprises an average of a dissimilarity measure between predictions from the lightweight student model and predictions from the teacher model.

13. The method of claim 1, wherein the task objective is over a labeled original dataset; and
wherein the distillation objective is over an extended dataset generated using data from the labeled original dataset.

14. The method of claim 13, wherein the dataset comprises original data and corresponding labels;
wherein the extended dataset comprises:
the original data; and
synthetic data generated from the original data.

15. The method of claim 14, further comprising:
generating the extended dataset;
wherein said generating the extended dataset comprises:
generating synthetic data from the original data using a generative model.

16. The method of claim 15, wherein said generating the synthetic data uses a diffusion-based method that processes subsets of original samples to generate each of a plurality of synthetic samples.

17. The method of claim 15, wherein said generating the extended dataset is task-agnostic.

18. The method of claim 1, wherein:
the pretrained network model includes at least two times a number of model parameters compared to the lightweight student network model; and/or
the pretrained network model requires at least two times an amount of computing resources compared to the lightweight student network model.

19. The method of claim 1, wherein said training the teacher model and training the lightweight student network model do not include finetuning the pretrained network model.

20. The method of claim 1, wherein the downstream task is an image processing task; and wherein the data comprises images.

21. The method of claim 20, wherein the image processing task comprises image classification, object detection, and/or semantic segmentation.

22. The method of claim 1, wherein said probing uses a dataset including original data and corresponding labels;
wherein said training the lightweight student model uses an extended dataset, the extended dataset comprising:
the original data; and
synthetic data generated from the original data;
wherein the original data comprises images.

23. The method of claim 1, wherein the pretrained network model comprises an encoder.

24. The method of claim 1, wherein the pretrained network model and the lightweight student network model comprise vision transformers.

25. A computer-implemented system for training a lightweight student network model for performing a task, the system comprising:
a processor;
a memory; and
executable instructions stored in the memory for causing the processor to perform a method comprising:
augmenting a pretrained network model with a task-specific prediction head to provide a teacher model, the pretrained network model being larger than the lightweight student network model;
training the teacher model on the task using a task objective;
training the lightweight student network model jointly using the task objective and a distillation objective, the distillation objective comprising a similarity between predictions from the lightweight student model and predictions from the trained teacher model.

26. A processor-based system for training a lightweight student network model for performing a task, the system comprising:
a teacher model for connecting to the lightweight student network model and having teacher model parameters, said teacher model comprising:
a backbone model that is larger than the lightweight student network model and having backbone model parameters; and
a task-specific prediction head connected downstream of said backbone model and having prediction head parameters;
a model optimization module configured to:
optimize the parameters of the prediction head, while the backbone model parameters are frozen, based on a task objective; and
after said optimizing the parameters of the prediction head, optimize parameters of the lightweight student network model, while the teacher model parameters are frozen, using at least on the task objective and a distillation objective, the distillation objective comprising a similarity between predictions from the lightweight student model and predictions from the teacher model; and
a training loss determination module configured to:
determine a supervised task loss for the task objective over original data, the original data having associated labels; and
determine a distillation loss for the distillation objective over extended data, the extended data comprising the original data and additional data generated using the original data.

27. The system of claim 26, further comprising an extended dataset generation module configured to generate the additional data from the original data, said extended dataset generation module comprising a synthetic data generation module for generating synthetic data from the original data.

28. A computer-implemented method for performing a task of navigating or controlling an autonomous device, the method comprising:
receiving a input image from an input device of the autonomous device;
processing the input image by a lightweight student network model and generating a prediction; and
processing the generated prediction to perform the task;
wherein the lightweight student network model having been trained by:
augmenting a pretrained network model with a task-specific prediction head to provide a teacher model, the pretrained network model being larger than the lightweight student network model;
training the teacher model on the task, said training the teacher model using a task objective; and
training the lightweight student network model jointly using at least the task objective and a distillation objective, the distillation objective comprising a similarity between predictions from the lightweight student model and predictions from the trained teacher model.

29. The method of claim 28, wherein the task further comprises an image processing task that comprises one or more of image classification, object detection, and/or semantic segmentation.

30. An autonomous device, comprising:
a memory for storing a lightweight student network model;
an input device for receiving an input image;
a processor for processing the input image by the lightweight student network model and generating a prediction, and for processing the generated prediction to perform a task of navigating or controlling the autonomous device;
wherein the lightweight student network model having been trained by:
augmenting a pretrained network model with a task-specific prediction head to provide a teacher model, the pretrained network model being larger than the lightweight student network model;
training the teacher model on the task, said training the teacher model using a task objective; and
training the lightweight student network model jointly using at least the task objective and a distillation objective, the distillation objective comprising a similarity between predictions from the lightweight student model and predictions from the trained teacher model.

31. The method of claim 30, wherein the task further comprises an image processing task that comprises one or more of image classification, object detection, and/or semantic segmentation.
